(19) United States
(12) Patent Application Publication
(10) Pub. No.: US 2008/0284317 A1
(43) Pub. Date: Nov. 20, 2008

(54) HYBRID OLED HAVING IMPROVED EFFICIENCY

(76) Inventors: Liang-Sheng Liao, Rochester, NY (US); Kevin P. Klubek, West Henrietta, NY (US); Joseph C. Deaton, Rochester, NY (US); Cynthia A. Pellow, Fairport, NY (US)

Correspondence Address: Frank Pincelli;Patent Legal Staff, Eastman Kodak Company, 343 State Street, Rochester, NY, 14650-2201, US

(21) Appl. No.: 11/749,875

(22) Filed: May 17, 2007

(51) Int. Cl. H01J 1/63

(52) U.S. Cl. 313/504

(57) ABSTRACT

An organic light-emitting device (OLED) including an anode; a cathode; a blue light-emitting layer disposed between the anode and the cathode and includes at least one blue host and at least one fluorescent blue dopant; a first light-emitting layer disposed between the anode and the blue light-emitting layer, including a first phosphorescent dopant and a host; and a second light-emitting layer disposed between the blue light-emitting layer and the cathode, including a second phosphorescent dopant and a host.

### CROSS REFERENCE TO RELATED APPLICATIONS

Reference is made to commonly-assigned U.S. patent application Ser. No. ______ filed concurrently herewith, entitled “Hybrid OLED With Fluorescent And Phosphorescent Layers”, by Joseph C. Deaton et al. and U.S. patent application Ser. No. ______ filed concurrently herewith, entitled “Hybrid Fluorescent/Phosphorescent OLEDS”, by Joseph C. Deaton et al., the disclosures of which are incorporated herein by reference.

### FIELD OF THE INVENTION

The present invention relates to organic light-emitting devices (OLEDs) or organic electroluminescent (EL) devices comprising a fluorescent blue light-emitting layer, a hole-transporting region including a first phosphorescent light-emitting layer doped with a phosphorescent dopant, and an electron-transporting region including a second phosphorescent light-emitting layer doped with a phosphorescent dopant, that can provide desirable emission with improved efficiency.

### BACKGROUND OF THE INVENTION

Organic light-emitting devices (OLEDs) or organic electroluminescent (EL) devices have been known for several decades, however, their performance limitations have represented a barrier for many applications. In the simplest form, an OLED is comprised of an anode for hole injection, a cathode for electron injection, and an organic medium sandwiched between these electrodes to support charge recombination and emission of light. Representative of earlier OLEDs are Gurnee et al. U.S. Pat. No. 3,172,862, issued Mar. 9, 1965; Gurnee U.S. Pat. No. 3,173,050, issued Mar. 9, 1965; Dresner, “Double Injection Electroluminescence in Anthracene”, RCA Review, 30, 322 (1969); and Dresner U.S. Pat. No. 3,710,167, issued Jan. 9, 1973. The organic layers in these devices, usually composed of a polycyclic aromatic hydrocarbon, were very thick (much greater than 1 μm). Consequently, operating voltages were very high, often >100V.

More recent OLEDs include an organic EL medium consisting of extremely thin layers (e.g. <1.0 μm) between the anode and the cathode. Herein, the term “organic EL medium” encompasses the layers between the anode and cathode. Reducing the thickness has lowered the resistance of the organic layers and enabled devices that operate at much lower voltage. In a basic two-layer OLED structure, described first in U.S. Pat. No. 4,356,429 by Tang, one organic layer of the EL medium adjacent to the anode is specifically chosen to transport holes, and therefore is referred to as the hole-transporting layer (HTL), and the other organic layer is specifically chosen to transport electrons and is referred to as the electron-transporting layer (ETL). Recombination of the injected holes and electrons within the organic EL medium results in efficient electroluminescence.

Based on the two-layer OLED structure, numerous OLEDs with alternative layer structures have been disclosed. For example, there are three-layer OLEDs that contain an organic light-emitting layer (LEL) between the HTL and the ETL, such as that disclosed by Adachi et al., “Electroluminescence in Organic Films with Three-Layer Structure”, Japanese Journal of Applied Physics, 27, L269 (1988), and by Tang et al., “Electroluminescence of Doped Organic Thin Films”, Journal of Applied Physics, 65, 3610 (1989). The LEL commonly include a host material doped with a guest material, otherwise known as a dopant. Further, there are other multilayer OLEDs that contain additional functional layers, such as a hole-injecting layer (HIL), and/or an electron-injecting layer (EIL), and/or an electron-blocking layer (EBL), and/or a hole-blocking layer (HBL) in the devices. These new structures have resulted in improved device performance.

In the following discussion, it should be understood that a fluorescent emissive layer refers to any light-emitting layer which contains a material that emits light via a singlet excited state, while a phosphorescent emissive layer refers to any light-emitting layer which contains a material that emits light via a triplet excited state.

Many light-emitting materials emit light from their excited singlet state by fluorescence. The excited singlet state can be created when excitons formed in an OLED transfer their energy to the singlet excited state of the dopant. However, only 25% of the excitons created in an OLED are singlet excitons. The remaining excitons are triplets, which cannot readily transfer their energy to the dopant to produce the singlet excited state of a dopant. This results in a large loss in efficiency since 75% of the excitons are not utilized in the light emission process.

Triplet excitons can transfer their energy to a dopant if the dopant has a triplet excited state that is low enough in energy. If the triplet state of the dopant is emissive it can produce light by phosphorescence. In many cases, singlet excitons can also transfer their energy to the lowest singlet excited state of the same dopant. The singlet excited state can often relax, by an intersystem crossing process, to the emissive triplet excited state. Thus, it is possible, by the proper choice of host and dopant, to collect energy from both the singlet and triplet excitons created in an OLED and to produce very efficient phosphorescent emission with an internal quantum efficiency of nearly 100%. The term electrophosphorescence is sometimes used to denote EL wherein the mechanism of luminescence is phosphorescence.

Recently, white OLEDs have been attracting more attention because they are potentially useful in both low-cost OLED displays and solid-state lighting. Phosphorescent materials can be utilized to produce a white OLED having highly efficient white emission, but the operational lifetime (or stability) is currently limited by the lifetime of the blue phosphorescent component. Fluorescent materials can be utilized to produce a white OLED having long operational lifetime, but the quantum efficiency is generally about three times lower than that of all-phosphorescent white OLEDs. In order to fabricate white OLEDs with both high efficiency and long operational lifetime, Tung et al. in U.S. Patent Application Publication No. 2006/0232194 A1 and Forrest et al. in U.S. Patent Application Publication No. 2006/0279203 A1 disclosed hybrid white OLED structures. Herein, a “hybrid” device is one that contains at least one fluorescent emissive layer and at least one phosphorescent emissive layer.

Tung et al. propose a hybrid white OLED structure, in U.S. Patent Application Publication No. 2006/0232194 A1, that comprises a cathode, a first emissive layer comprising a fluorescent blue-emitting material, a second emissive layer comprising a phosphorescent-emitting material, and an anode. Forrest et al. proposed more comprehensive hybrid white OLED structures, in U.S. Patent Application Publication No. 2006/0279203 A1, that include both Tung et al.'s structure and other structures having the phosphorescent LEL(s) sandwiched in between two fluorescent blue light-emitting layers and separated by at least one spacer layer. Moreover, Forrest et al. disclose that the singlet excitons generated in the fluorescent blue light-emitting layer can be confined by a spacer layer to produce fluorescent blue emission within the fluorescent blue light-emitting layer, and the triplet excitons generated in the fluorescent blue light-emitting layer can diffuse through the spacer layer into the phosphorescent LEL to produce phosphorescent green and red emissions.

Tung et al's and Forrest et al's aforementioned disclosures are important to fabricate white OLEDs having both high-efficiency and long operational lifetime. However, there is still a need to further improve the hybrid white OLED structure.

### SUMMARY OF THE INVENTION

By having a first and a second phosphorescent layer on opposite sides of the blue light-emitting layer, diffusion of triplet excitons generated in the blue light-emitting layer will encounter the first or the second phosphorescent layer thereby improving efficiency.

It is therefore an object of the present invention to improve the triplet exciton harvesting efficiency in a hybrid OLED.

It is yet another object of the present invention to reduce drive voltage and increase power efficiency of a hybrid OLED.

These objects are achieved by an organic light-emitting device (OLED) comprising:

(a) an anode;

(b) a cathode;

(c) a blue light-emitting layer disposed between the anode and the cathode and includes at least one blue host and at least one fluorescent blue dopant;

(d) a first light-emitting layer disposed between the anode and the blue light-emitting layer, including a first phosphorescent dopant and a host; and

(e) a second light-emitting layer disposed between the blue light-emitting layer and the cathode, including a second phosphorescent dopant and a host.

### BRIEF DESCRIPTION OF THE DRAWINGS

FIG. 1 shows a cross-sectional view of one embodiment of an OLED prepared in accordance with the present invention;

FIG. 2 shows a cross-sectional view of another embodiment of an OLED prepared in accordance with the present invention;

FIG. 3 shows a cross-sectional view of yet another embodiment of an OLED prepared in accordance with the present invention;

FIG. 4 shows a cross-sectional view of yet another embodiment of an OLED prepared in accordance with the present invention;

FIG. 5 shows a cross-sectional view of yet another embodiment of an OLED prepared in accordance with the present invention;

FIG. 6 shows a cross-sectional view of yet another embodiment of an OLED prepared in accordance with the present invention;

FIG. 7 shows the EL spectra of Devices 1 and 2 tested at 20 mA/cm²;

FIG. 8 shows the EL spectra of Devices 3 and 4 tested at 20 mA/cm²; and

FIG. 9 shows the EL spectra of Devices 6, 7, and 9 tested at 1.0 mA/cm².

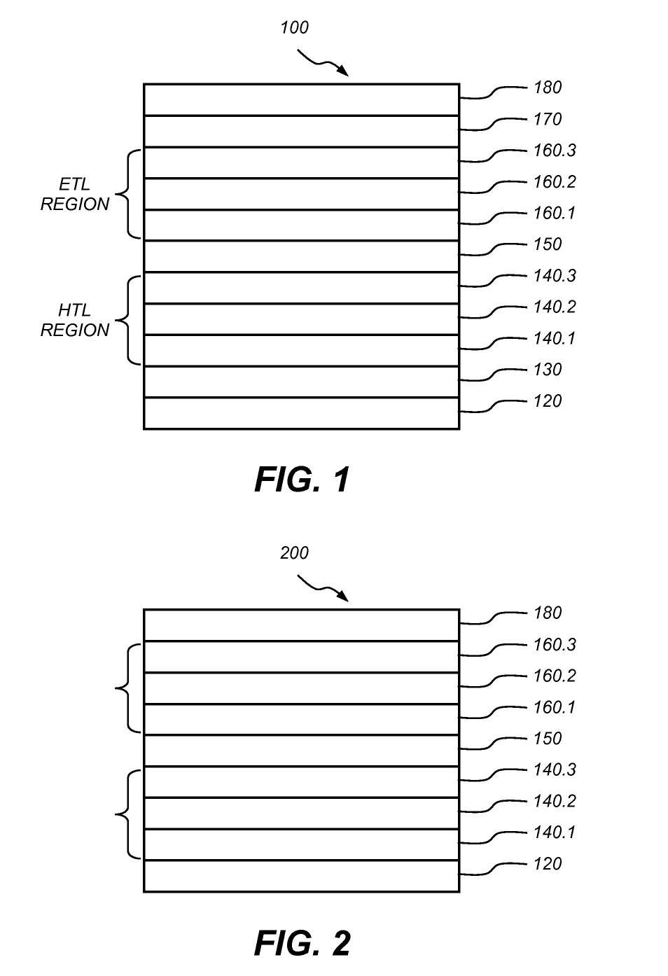

It will be understood that FIGS. 1-6 are not to scale since the individual layers are too thin and the thickness differences of various layers are too great to permit depiction to scale.

### DETAILED DESCRIPTION OF THE INVENTION

The present invention can be employed in many OLED configurations using small molecule materials, oligomeric materials, polymeric materials, or combinations thereof. These include from very simple structures having a single anode and cathode to more complex devices, such as passive matrix displays having orthogonal arrays of anodes and cathodes to form pixels, and active-matrix displays where each pixel is controlled independently, for example, with thin film transistors (TFTs). There are numerous configurations of the organic layers wherein the present invention is successfully practiced.

A typical structure according to the present invention and especially useful for a small molecule device is shown in FIG. 1. OLED 100 in FIG. 1 includes an anode 120, a HIL 130, a HTL 140.1, a first phosphorescent LEL 140.2 (denoted as “first phosphor. LEL” in the figure), a first spacer 140.3, a fluorescent blue LEL 150, a second spacer 160.1, a second phosphorescent LEL 160.2 (denoted as “second phosphor. LEL” in the figure), an ETL 160.3, an EIL 170 and a cathode 180. Wherein, layers 140.1, 140.2, and 140.3 form an HTL region; and layers 160.1, 160.2, and 160.3 form an ETL region. OLED 100 can be operated by applying an electric potential produced by a voltage/current source between the pair of the electrodes, anode 120 and cathode 180.

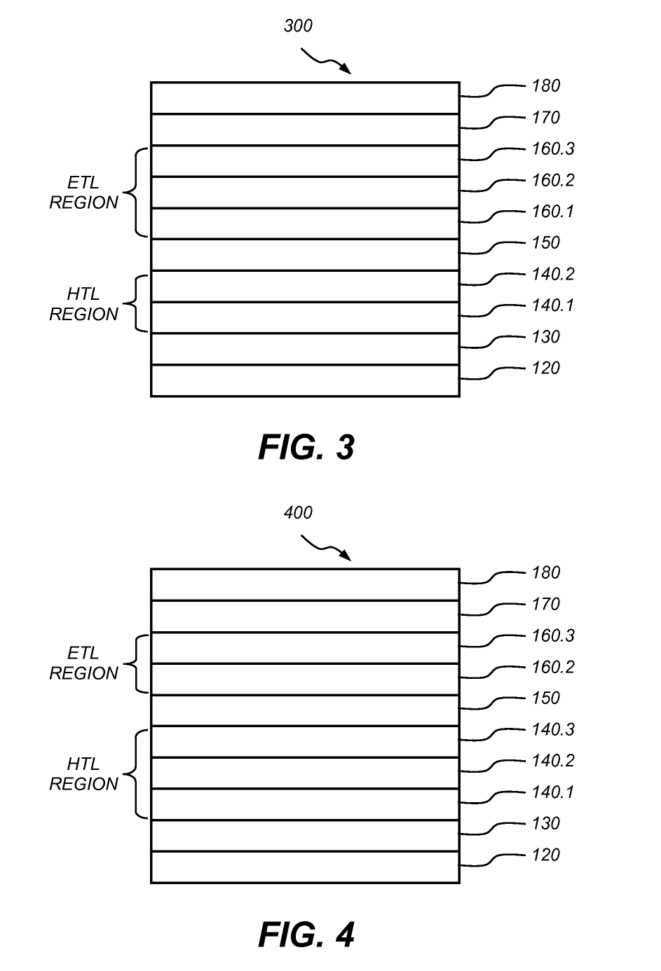

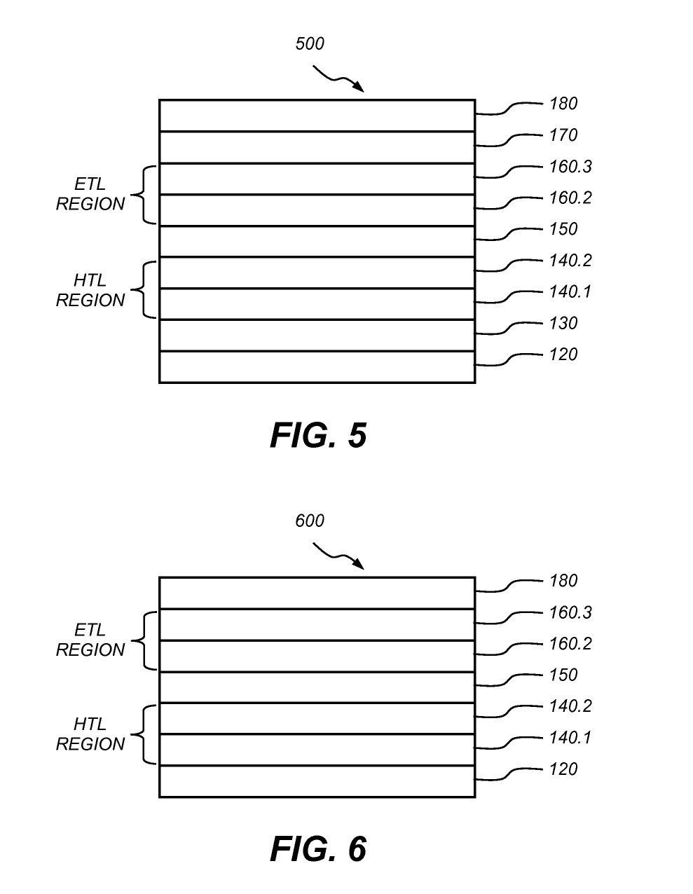

Shown in FIGS. 2, 3, 4, 5, and 6 are OLED 200, OLED 300, OLED 400, OLED 500, and OLED 600, respectively, which are additional embodiments of OLEDs prepared in accordance with the present invention. OLED 200 in FIG. 2 is the same as OLED 100 except that there is no HIL 130 nor EIL 170; OLED 300 in FIG. 3 is the same as OLED 100 except that there is no first spacer 140.3; OLED 400 in FIG. 4 is the same as OLED 100 except that there is no second spacer 160.1. OLED 500 in FIG. 5 is the same as OLED 100 except that there is no first spacer 140.3 or second spacer 160.1, and OLED 600 in FIG. 6 is the same as OLED 100 except that there is no HIL 130, first spacer 140.3, second spacer 160.1, or EIL 170.

The following is the description of the layer structure, material selection, and fabrication process for the OLED embodiments shown in FIGS. 1-6.

When the desired EL emission is viewed through the anode, anode 120 should be transparent or substantially transparent to the emission of interest. Common transparent anode materials used in this invention are indium-tin oxide (ITO), indium-zinc oxide (IZO) and tin oxide, but other metal oxides can work including, but not limited to, aluminum- or indium-doped zinc oxide, magnesium-indium oxide, and nickel-tungsten oxide. In addition to these oxides, metal nitrides, such as gallium nitride, and metal selenides, such as zinc selenide, and metal sulfides, such as zinc sulfide, can be used as the anode 120. For applications where EL emission is viewed only through the cathode 170, the transmissive characteristics of the anode 120 are immaterial and any conductive material can be used, transparent, opaque or reflective. Example conductors for this application include, but are not limited to, gold, iridium, molybdenum, palladium, and platinum. Typical anode materials, transmissive or otherwise, have a work function of 4.1 eV or greater. Desired anode materials are commonly deposited by any suitable means such as evaporation, sputtering, chemical vapor deposition, or electrochemical means. Anodes can be patterned using well-known photolithographic processes. Optionally, anodes may be polished prior to application of other layers to reduce surface roughness so as to minimize short circuits or enhance reflectivity.

Although it is not always necessary, it is often useful to provide an HIL in the OLEDs. HIL 130 in the OLEDs can serve to facilitate hole injection from the anode into the HTL, thereby reducing the drive voltage of the OLEDs. Suitable materials for use in HIL 130 include, but are not limited to, porphyrinic compounds as described in U.S. Pat. No. 4,720,432 and some aromatic amines, for example, 4,4′,4″-tris[(3-ethylphenyl)phenylamino]triphenylamine (m-TDATA). Alternative hole-injecting materials reportedly useful in OLEDs are described in EP 0 891 121 A1 and EP 1 029 909 A1. Aromatic tertiary amines discussed below can also be useful as hole-injecting materials. Other useful hole-injecting materials such as dipyrazino[2,3-f:2′,3′-h]quinoxalinehexacarbonitrile (HAT-CN) are described in U.S. Patent Application Publication No. 2004/0113547 A1 and U.S. Pat. No. 6,720,573. In addition, a p-type doped organic layer is also useful for the HIL as described in U.S. Pat. No. 6,423,429. The term “p-type doped organic layer” means that this layer has semiconducting properties after doping, and the electrical current through this layer is substantially carried by the holes. The conductivity is provided by the formation of a charge-transfer complex as a result of hole transfer from the dopant to the host material.

The thickness of the HIL 130 is in the range of from 0.1 nm to 200 nm, preferably, in the range of from 0.5 nm to 150 nm.

The HTL 140.1 contains at least one hole-transporting material such as an aromatic tertiary amine, where the latter is understood to be a compound containing at least one trivalent nitrogen atom that is bonded only to carbon atoms, at least one of which is a member of an aromatic ring. In one form the aromatic tertiary amine is an arylamine, such as a monoarylamine, diarylamine, triarylamine, or a polymeric arylamine. Exemplary monomeric triarylamines are illustrated by Klupfel et al. U.S. Pat. No. 3,180,730. Other suitable triarylamines substituted with one or more vinyl radicals or at least one active hydrogen-containing group are disclosed by Brantley, et al. in U.S. Pat. Nos. 3,567,450 and 3,658,520.

A more preferred class of aromatic tertiary amines are those which include at least two aromatic tertiary amine moieties as described in U.S. Pat. Nos. 4,720,432 and 5,061,569. Such compounds include those represented by structural Formula (A)

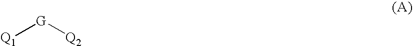

wherein:

Q₁ and Q₂ are independently selected aromatic tertiary amine moieties; and

G is a linking group such as an arylene, cycloalkylene, or alkylene group of a carbon to carbon bond.

In one embodiment, at least one of Q₁ or Q₂ contains a polycyclic fused ring structure, e.g., a naphthalene. When G is an aryl group, it is conveniently a phenylene, biphenylene, or naphthalene moiety.

A useful class of triarylamines satisfying structural Formula A and containing two triarylamine moieties is represented by structural Formula (B)

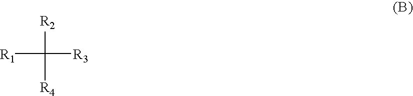

wherein:

R₁ and R₂ each independently represents a hydrogen atom, an aryl group, or an alkyl group or R₁ and R₂ together represent the atoms completing a cycloalkyl group; and

R₃ and R₄ each independently represents an aryl group, which is in turn substituted with a diaryl substituted amino group, as indicated by structural Formula (C):

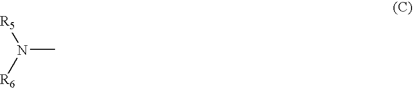

wherein R₅ and R₆ are independently selected aryl groups. In one embodiment, at least one of R₅ or R₆ contains a polycyclic fused ring structure, e.g., a naphthalene.

Another class of aromatic tertiary amines are the tetraaryldiamines. Desirable tetraaryldiamines include two diarylamino groups, such as indicated by Formula (C), linked through an arylene group. Useful tetraaryldiamines include those represented by Formula (D)

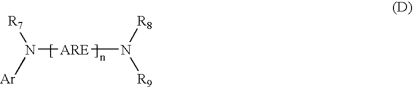

wherein:

each ARE is an independently selected arylene group, such as a phenylene or anthracene moiety;

n is an integer of from 1 to 4; and

Ar, R₇, R₈, and R₉ are independently selected aryl groups. In a typical embodiment, at least one of Ar, R₇, R₈, and R₉ is a polycyclic fused ring structure, e.g., a naphthalene.

Another class of the hole-transporting material comprises a material of formula (E):

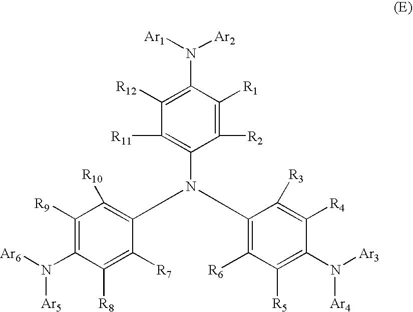

In formula (E), Ar₁-Ar₆ independently represent aromatic groups, for example, phenyl groups or tolyl groups;

R₁-R₁₂ independently represent hydrogen or independently selected substitutent, for example an alkyl group containing from 1 to 4 carbon atoms, an aryl group, a substituted aryl group.

The various alkyl, alkylene, aryl, and arylene moieties of the foregoing structural Formulae (A), (B), (C), (D), and (E) can each in turn be substituted. Typical substitutents include alkyl groups, alkoxy groups, aryl groups, aryloxy groups, and halogen such as fluoride, chloride, and bromide. The various alkyl and alkylene moieties typically contain from about 1 to 6 carbon atoms. The cycloalkyl moieties can contain from 3 to about 10 carbon atoms, but typically contain five, six, or seven ring carbon atoms, e.g. cyclopentyl, cyclohexyl, and cycloheptyl ring structures. The aryl and arylene moieties are typically phenyl and phenylene moieties.

The HTL is formed of a single or a mixture of aromatic tertiary amine compounds. Specifically, one can employ a triarylamine, such as a triarylamine satisfying the Formula (B), in combination with a tetraaryldiamine, such as indicated by Formula (D). When a triarylamine is employed in combination with a tetraaryldiamine, the latter is positioned as a layer interposed between the triarylamine and the electron injecting and transporting layer. Aromatic tertiary amines are useful as hole-injecting materials also. Illustrative of useful aromatic tertiary amines are the following:
1,1-bis(4-di-p-tolylaminophenyl)cyclohexane;
1,1-bis(4-di-p-tolylaminophenyl)-4-phenylcyclohexane;
1,5-bis[N-(1-naphthyl)-N-phenylamino]naphthalene;
2,6-bis(di-p-tolylamino)naphthalene;
2,6-bis[di-(1-naphthyl)amino]naphthalene;
2,6-bis[N-(1-naphthyl)-N-(2-naphthyl)amino]naphthalene;
2,6-bis[N,N-di(2-naphthyl)amine]fluorene;
4-(di-p-tolylamino)-4′-[4(di-p-tolylamino)-styryl]stilbene;
4,4′-bis(diphenylamino)quadriphenyl;
4,4″-bis[N-(1-anthryl)-N-phenylamino]-p-terphenyl;
4,4′-bis[N-(1-coronenyl)-N-phenylamino]biphenyl;
4,4′-bis[N-(1-naphthyl)-N-phenylamino]biphenyl (NPB);
4,4′-bis[N-(1-naphthyl)-N-(2-naphthyl)amino]biphenyl (TNB);
4,4″-bis[N-(1-naphthyl)-N-phenylamino]ₚ-terphenyl;
4,4′-bis[N-(2-naphthacenyl)-N-phenylamino]biphenyl;
4,4′-bis[N-(2-naphthyl)-N-phenylamino]biphenyl;
4,4′-bis[N-(2-perylenyl)-N-phenylamino]biphenyl;
4,4′-bis[N-(2-phenanthryl)-N-phenylamino]biphenyl;
4,4′-bis[N-(2-pyrenyl)-N-phenylamino]biphenyl;
4,4′-bis[N-(3-acenaphthenyl)-N-phenylamino]biphenyl;
4,4′-bis[N-(3-methylphenyl)-N-phenylamino]biphenyl (TPD);
4,4′-bis[N-(8-fluoranthenyl)-N-phenylamino]biphenyl;
4,4′-bis[N-(9-anthryl)-N-phenylamino]biphenyl;
4,4′-bis{N-phenyl-N-[4-(1-naphthyl)-phenyl]amino}biphenyl;
4,4′-bis[N-phenyl-N-(2-pyrenyl)amino]biphenyl;
4,4′,4″-tris[(3-methylphenyl)phenylamino]triphenylamine (m-TDATA);
Bis(4-dimethylamino-2-methylphenyl)-phenylmethane;
N-phenylcarbazole;
N,N′-bis[4-([1,1′-biphenyl]-4-ylphenylamino)phenyl]-N,N′-di-1-naphthalenyl-[1,1′-biphenyl]-4,4′-diamine;
N,N′-bis[4-(di-1-naphthalenylamino)phenyl]-N,N′-di-1-naphthalenyl-[1,1′-biphenyl]-4,4′-diamine;
N,N′-bis[4-[(3-methylphenyl)phenylamino]phenyl]-N,N′-diphenyl-[1,1′-biphenyl]-4,4′-diamine;
N,N-bis[4-(diphenylamino)phenyl]-N′,N′-diphenyl-[1,1′-biphenyl]-4,4′-diamine;
N,N′-di-1-naphthalenyl-N,N′-bis[4-(1-naphthalenylphenylamino)phenyl]-[1,1′-biphenyl]-4,4′-diamine;
N,N′-di-1-naphthalenyl-N,N′-bis[4-(2-naphthalenylphenylamino)phenyl]-[1,1′-biphenyl]-4,4′-diamine;
N,N,N-tri(p-tolyl)amine;
N,N,N′,N′-tetra-p-tolyl-4-4′-diaminobiphenyl;
N,N,N′,N′-tetraphenyl-4,4′-diaminobiphenyl;
N,N,N′,N′-tetra-1-naphthyl-4,4′-diaminobiphenyl;
N,N,N′,N′-tetra-2-naphthyl-4,4′-diaminobiphenyl; and
N,N,N′,N′-tetra(2-naphthyl)-4,4″-diamino-p-terphenyl.

Another class of useful hole-transporting materials includes polycyclic aromatic compounds as described in EP 1 009 041. Tertiary aromatic amines with more than two amine groups can be used including oligomeric materials. In addition, polymeric hole-transporting materials are used such as poly(N-vinylcarbazole) (PVK), polythiophenes, polypyrrole, polyaniline, and copolymers such as poly(3,4-ethylenedioxythiophene)/poly(4-styrenesulfonate) also called PEDOT/PSS.

The thickness of the HTL 140.1 is in the range of from 5 nm to 200 nm, preferably, in the range of from 10 nm to 150 nm.

The first phosphorescent LEL 140.2 includes a host (or host material) and at least one phosphorescent dopant (or dopant material).

A suitable host in the first phosphorescent LEL 140.2 should be selected so that transfer of a triplet exciton can occur efficiently from the host to the phosphorescent dopant(s) but cannot occur efficiently from the phosphorescent dopant(s) to the host. Therefore, it is highly desirable that the triplet energy of the host be higher than the triplet energy of the phosphorescent dopant. Generally speaking, a large triplet energy implies a large optical band gap. However, the band gap of the host should not be chosen so large as to cause an unacceptable barrier to injection of holes into the fluorescent blue LEL and an unacceptable increase in the drive voltage of the OLED. The host in the first phosphorescent LEL 140.2 may include the aforementioned hole-transporting material used for the HTL 140.1, as long as it has a triplet energy higher than that of the phosphorescent dopant in the layer. The host used in the first phosphorescent LEL 140.2 can be the same as or different from the hole-transporting material used in the HTL 140.1. In some cases, the host in the first phosphorescent LEL 140.2 may also suitably include an electron-transporting material (it will be discussed thereafter), as long as it has a triplet energy higher than that of the phosphorescent dopant in the first phosphorescent LEL 140.2.

In addition to the aforementioned hole-transporting materials in the HTL 140.1, there are several other classes of hole-transporting materials suitable for use as the host in the first phosphorescent LEL 140.2.

One desirable host in the first phosphorescent LEL 140.2 includes a hole-transporting material of formula (F):

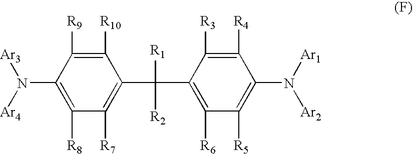

In formula (F), R₁ and R₂ represent substitutents, provided that R₁ and R₂ can join to form a ring. For example, R₁ and R₂ can be methyl groups or join to form a cyclohexyl ring;

Ar₁-Ar₄ represent independently selected aromatic groups, for example phenyl groups or tolyl groups;

R₃-R₁₀ independently represents hydrogen, alkyl, substituted alkyl, aryl, substituted aryl group.

Examples of suitable materials include, but are not limited to:
1,1-Bis(4-(N,N-di-p-tolylamino)phenyl)cyclohexane (TAPC);
1,1-Bis(4-(N,N-di-p-tolylamino)phenyl)cyclopentane;
4,4′-(9H-fluoren-9-ylidene)bis[N,N-bis(4-methylphenyl)-benzenamine;
1,1-Bis(4-(N,N-di-p-tolylamino)phenyl)-4-phenylcyclohexane;
1,1-Bis(4-(N,N-di-p-tolylamino)phenyl)-4-methylcyclohexane;
1,1-Bis(4-(N,N-di-p-tolylamino)phenyl)-3-phenylpropane;
Bis[4-(N,N-diethylamino)-2-methylphenyl](4-methylpenyl)methane;
Bis[4-(N,N-diethylamino)-2-methylphenyl](4-methylphenyl)ethane;
4-(4-Diethylaminophenyl)triphenylmethane;
4,4′-Bis(4-diethylaminophenyl)diphenylmethane.

A useful class of triarylamines suitable for use as the host in the first phosphorescent LEL 140.2 includes carbazole derivatives such as those represented by formula (G):

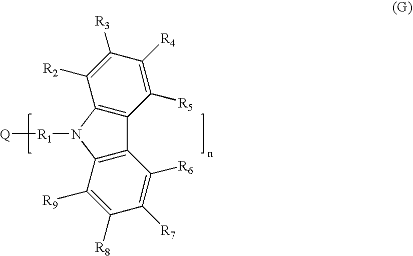

In formula (G), Q independently represents nitrogen, carbon, an aryl group, or substituted aryl group, preferably a phenyl group;

R₁ is preferably an aryl or substituted aryl group, and more preferably a phenyl group, substituted phenyl, biphenyl, substituted biphenyl group;

R₂ through R₇ are independently hydrogen, alkyl, phenyl or substituted phenyl group, aryl amine, carbazole, or substituted carbazole;

and n is selected from 1 to 4.

Another useful class of carbazoles satisfying structural formula (G) is represented by formula (H):

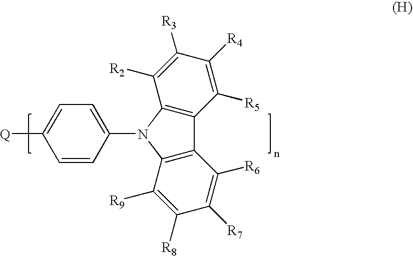

wherein n is an integer from 1 to 4;

Q is nitrogen, carbon, an aryl, or substituted aryl;

R₂ through R₇ are independently hydrogen, an alkyl group, phenyl or substituted phenyl, an aryl amine, a carbazole and substituted carbazole.

Illustrative of useful substituted carbazoles are the following:
4-(9H-carbazol-9-yl)-N,N-bis[4-(9H-carbazol-9-yl)phenyl]-benzenamine (TCTA);
4-(3-phenyl-9H-carbazol-9-yl)-N,N-bis[4(3-phenyl-9H-carbazol-9-yl)phenyl]-benzenamine;
9,9′-[5′-[4-(9H-carbazol-9-yl)phenyl][1,1′:3′,1″-terphenyl]-4,4″-diyl]bis-9H-carbazole.
9,9′-(2,2′-dimethyl[1,1′-biphenyl]-4,4′-diyl)bis-9H-carbazole (CDBP);
9,9′-[1,1′-biphenyl]-4,4′-diylbis-9H-carbazole (CBP);
9,9′-(1,3-phenylene)bis-9H-carbazole (mCP);
9,9′-(1,4-phenylene)bis-9H-carbazole;
9,9′,9″-(1,3,5-benzenetriyl)tris-9H-carbazole;
9,9′-(1,4-phenylene)bis[N,N,N′,N′-tetraphenyl-9H-carbazole-3,6-diamine;
9-[4-(9H-carbazol-9-yl)phenyl]-N,N-diphenyl-9H-carbazol-3-amine;
9,9′-(1,4-phenylene)bis[N,N-diphenyl-9H-carbazol-3-amine;
9-[4-(9H-carbazol-9-yl)phenyl]-N,N,N′,N′-tetraphenyl-9H-carbazole-3,6-diamine.

Suitable phosphorescent dopants for use in the first phosphorescent LEL 140.2 can be selected from the phosphorescent materials described by formula (J) below:

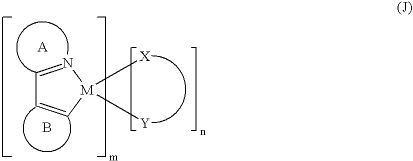

wherein:

A is a substituted or unsubstituted heterocyclic ring containing at least one nitrogen atom;

B is a substituted or unsubstituted aromatic or heteroaromatic ring, or ring containing a vinyl carbon bonded to M;

X—Y is an anionic bidentate ligand;

m is an integer from 1 to 3 and n in an integer from 0 to 2 such that m+n=3 for M=Rh or Ir; or

m is an integer from 1 to 2 and n in an integer from 0 to 1 such that m+n=2 for M=Pt or Pd.

Compounds according to formula (J) may be referred to as C,N- (or ĈN-) cyclometallated complexes to indicate that the central metal atom is contained in a cyclic unit formed by bonding the metal atom to carbon and nitrogen atoms of one or more ligands. Examples of heterocyclic ring A in formula (J) include substituted or unsubstituted pyridine, quinoline, isoquinoline, pyrimidine, indole, indazole, thiazole, and oxazole rings. Examples of ring B in formula (J) include substituted or unsubstituted phenyl, napthyl, thienyl, benzothienyl, furanyl rings. Ring B in formula (J) may also be a N-containing ring such as pyridine, with the proviso that the N-containing ring bonds to M through a C atom as shown in formula (J) and not the N atom.

An example of a tris-C,N-cyclometallated complex according to formula (J) with m=3 and n=0 is tris(2-phenyl-pyridinato-N,C^{2′}-)Iridium(III), shown below in stereodiagrams as facial (fac-) or meridional (mer-) isomers.

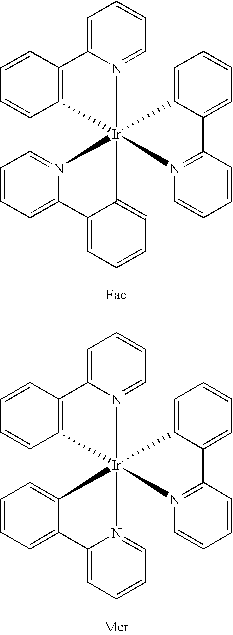

Generally, facial isomers are preferred since they are often found to have higher phosphorescent quantum yields than the meridional isomers. Additional examples of tris-C,N-cyclometallated phosphorescent materials according to formula (J) are tris(2-(4′-methylphenyl)pyridinato-N,C^{2′})Iridium(III), tris(3-phenylisoquinolinato-N,C^{2′})Iridium(III), tris(2-phenylquinolinato-N,C^{2′})Iridium(III), tris(1-phenylisoquinolinato-N,C^{2′})Iridium(III), tris(1-(4′-methylphenyl)isoquinolinato-N,C^{2′})Iridium(III), tris(2-(4′,6′-difluorophenyl)-pyridinato-N,C^{2′})Iridium(III), tris(2-((5′-phenyl)- phenyl)pyridinato-N,C^{2′})Iridium(III), tris(2-(2′-benzothienyl)pyridinato-N,C^{3′})Iridium(III), tris(2-phenyl-3,3′ dimethyl)indolato-N,C^{2′})Ir(III), tris(1-phenyl-1H-indazolato-N,C^{2′})Ir(III).

Of these, tris(1-phenylisoquinoline)iridium(III) (also referred to as Ir(piq)₃) and tris(2-phenylpyridine)iridium (also referred to as Ir(ppy)₃) are particularly suitable for this invention.

Tris-C,N-cyclometallated phosphorescent materials also include compounds according to formula (J) wherein the monoanionic bidentate ligand X—Y is another C,N-cyclometallating ligand. Examples include bis(1-phenylisoquinolinato-N,C^{2′})(2-phenylpyridinato-N,C^{2′})Iridium(III) and bis(2-phenylpyridinato-N,C^{2′}) (1-phenylisoquinolinato-N,C^{2′})Iridium(III). Synthesis of such tris-C,N-cyclometallated complexes containing two different C,N-cyclometallating ligands may be conveniently synthesized by the following steps. First, a bis-C,N-cyclometallated diiridium dihalide complex (or analogous dirhodium complex) is made according to the method of Nonoyama (Bull. Chem. Soc. Jpn., 47, 767 (1974)). Secondly, a zinc complex of the second, dissimilar C,N-cyclometallating ligand is prepared by reaction of a zinc halide with a lithium complex or Grignard reagent of the cyclometallating ligand. Third, the thus formed zinc complex of the second C,N-cyclometallating ligand is reacted with the previously obtained bis-C,N-cyclometallated diiridium dihalide complex to form a tris-C,N-cyclometallated complex containing the two different C,N-cyclometallating ligands. Desirably, the thus obtained tris-C,N-cyclometallated complex containing the two different C,N-cyclometallating ligands may be converted to an isomer wherein the C atoms bonded to the metal (e.g. Ir) are all mutually cis by heating in a suitable solvent such as dimethyl sulfoxide.

Suitable phosphorescent materials according to formula (J) may in addition to the C,N-cyclometallating ligand(s) also contain monoanionic bidentate ligand(s) X—Y that are not C,N-cyclometallating. Common examples are beta-diketonates such as acetylacetonate, and Schiff bases such as picolinate. Examples of such mixed ligand complexes according to formula (J) include bis(2-phenylpyridinato-N,C^{2′})Iridium(III)(acetylacetonate), bis(2-(2′-benzothienyl)pyridinato-N,C^{3′})Iridium(III)(acetylacetonate), and bis(2-(4′,6′-difluorophenyl)-pyridinato-N,C^{2′})Iridium(III)(picolinate).

Other important phosphorescent materials according to formula (J) include C,N-cyclometallated Pt(II) complexes such as cis-bis(2-phenylpyridinato-N,C^{2′})platinum(II), cis-bis(2-(2′-thienyl)pyridinato-N,C^{3′})platinum(II), cis-bis(2-(2′-thienyl)quinolinato-N,C^{5′})platinum(II), or (2-(4′,6′-difluorophenyl)pyridinato-N,C^{2′})platinum(II)(acetylacetonate).

The emission wavelengths (color) of C,N-cyclometallated phosphorescent materials according to formula (J) are governed principally by the lowest energy optical transition of the complex and hence by the choice of the C,N-cyclometallating ligand. For example, 2-phenyl-pyridinato-N,C^{2′} complexes are typically green emissive while 1-phenyl-isoquinolinolato-N,C^{2′} complexes are typically red emissive. In the case of complexes having more than one C,N-cyclometallating ligand, the emission will be that of the ligand having the property of longest wavelength emission. Emission wavelengths may be further shifted by the effects of substitutent groups on the C,N-cyclometallating ligands. For example, substitution of electron donating groups at appropriate positions on the N-containing ring A or electron accepting groups on the C-containing ring B tend to blue-shift the emission relative to the unsubstituted C,N-cyclometallated ligand complex. Selecting a monodentate anionic ligand X,Y in formula (J) having more electron accepting properties also tends to blue-shift the emission of a C,N-cyclometallated ligand complex. Examples of complexes having both monoanionic bidentate ligands possessing electron accepting properties and electron accepting substitutent groups on the C-containing ring B include bis(2-(4′,6′-difluorophenyl)-pyridinato-N,C^{2′})iridium(III)(picolinate) and bis(2-(4′,6′-difluorophenyl)-pyridinato-N,C^{2′})iridium(III)(tetrakis(1-pyrazolyl)borate).

The central metal atom in phosphorescent materials according to formula (J) may be Rh or Ir (m+n=3) and Pd or Pt (m+n=2). Preferred metal atoms are Ir and Pt since they tend to give higher phosphorescent quantum efficiencies according to the stronger spin-orbit coupling interactions generally obtained with elements in the third transition series.

In addition to bidentate C,N-cyclometallating complexes represented by formula (J), many suitable phosphorescent materials contain multidentate C,N-cyclometallating ligands. Phosphorescent materials having tridentate ligands suitable for use in the present invention are disclosed in U.S. Pat. No. 6,824,895 B1 and references therein, incorporated in their entirety herein by reference. Phosphorescent materials having tetradentate ligands suitable for use in the present invention are described by the following formulae:

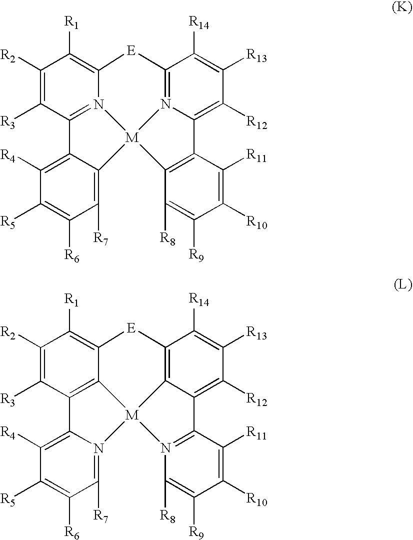

wherein:

M is Pt or Pd;

R¹-R⁷ represent hydrogen or independently selected substitutents, provided that R¹ and R², R² and R³, R³ and R⁴, R⁴ and R⁵, R⁵ and R⁶, as well as R⁶ and R⁷ may join to form a ring group;

R⁸-R¹⁴ represent hydrogen or independently selected substitutents, provided that R⁸ and R⁹, R⁹ and R¹⁰, R¹⁰ and R¹¹, R¹¹ and R¹², R¹² and R¹³, as well as R¹³ and R¹⁴, may join to form a ring group;

E represents a bridging group selected from the following:

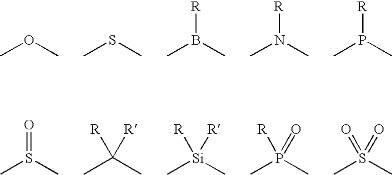

wherein R and R′ represent hydrogen or independently selected substitutents; provided R and R′ may combine to form a ring group.

One desirable tetradentate C,N-cyclometallated phosphorescent material suitable for use in as the phosphorescent dopant is represented by the following formula:

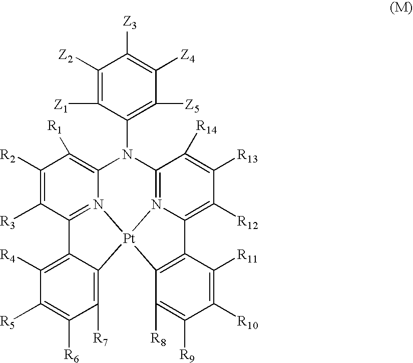

wherein,

R¹-R⁷ represent hydrogen or independently selected substitutents, provided that R¹ and R², R² and R³, R³ and R⁴, R⁴ and R⁵, R⁵ and R⁶, as well as R⁶ and R⁷ may combine to form a ring group;

R⁸-R¹⁴ represent hydrogen or independently selected substitutents, provided that R⁸ and R⁹, R⁹ and R¹⁰, R¹⁰ and R¹¹, R¹¹ and R¹², R¹² and R¹³, as well as R¹³ and R¹⁴ may combine to form a ring group;

Z¹-Z⁵ represent hydrogen or independently selected substitutents, provided that Z¹ and Z², Z² and Z³, Z³ and Z⁴, as well as Z⁴ and Z⁵ may combine to form a ring group.

Specific examples of phosphorescent materials having tetradentate C,N-cyclometallating ligands suitable for use in the present invention include compounds (M-1), (M-2) and (M-3) represented below.

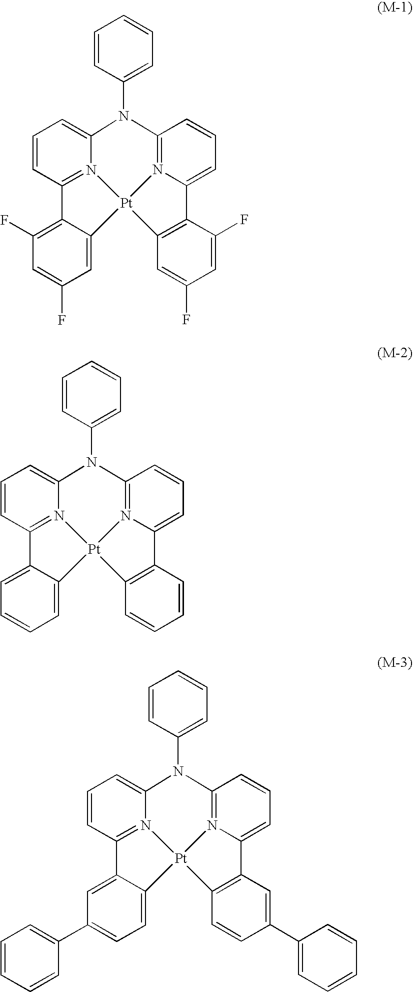

Phosphorescent materials having tetradentate C,N-cyclometallating ligands may be synthesized by reacting the tetradentate C,N-cyclometallating ligand with a salt of the desired metal, such as K₂PtCl₄, in a proper organic solvent such as glacial acetic acid to form the phosphorescent material having tetradentate C,N-cyclometallating ligands. A tetraakylammonium salt such as tetrabutylammonium chloride can be used as a phase transfer catalyst to accelerate the reaction.

Other phosphorescent materials that do not involve C,N-cyclometallating ligands are known. Phosphorescent complexes of Pt(II), Ir(I), and Rh(I) with maleonitriledithiolate have been reported (Johnson et al., J. Am. Chem. Soc., 105, 1795 (1983)). Re(I) tricarbonyl diimine complexes are also known to be highly phosphorescent (Wrighton and Morse, J. Am. Chem. Soc., 96, 998 (1974); Stufkens, Comments Inorg. Chem., 13, 359 (1992); Yam, Chem. Commun., 789 (2001)). Os(II) complexes containing a combination of ligands including cyano ligands and bipyridyl or phenanthroline ligands have also been demonstrated in a polymer OLED (Ma et al., Synthetic Metals, 94, 245 (1998)).

Porphyrin complexes such as 2,3,7,8,12,13,17,18-octaethyl-21H, 23H-porphine platinum(II) are also useful phosphorescent dopants.

Still other examples of useful phosphorescent materials include coordination complexes of the trivalent lanthamides such as Tb³⁺ and Eu³⁺ (Kido et al., Chem. Lett., 657 (1990); J. Alloys and Compounds, 192, 30 (1993); Jpn. J. Appl. Phys., 35, L394 (1996) and Appl. Phys. Lett., 65, 2124 (1994)).

The phosphorescent dopant in the first phosphorescent LEL 140.2 is typically present in an amount of from 1 to 20% by volume of the LEL, and conveniently from 2 to 8% by volume of the LEL. In some embodiments, the phosphorescent dopant(s) may be attached to one or more host materials. Furthermore, the host materials may be polymers. The phosphorescent dopant in the first phosphorescent light-emitting layer is selected from green and red phosphorescent materials.

The thickness of the first phosphorescent LEL 140.2 is greater than 0.5 nm, preferably, in the range of from 1.0 nm to 40 nm.

The first spacer 140.3 may contain at least one hole-transporting material. The hole-transporting material used in the first spacer 140.3 is selected from the hole-transporting materials discussed in the HTL 140.1 or in the first phosphorescent LEL 140.2. The hole-transporting material used in the first spacer 140.3 can be the same as or different from the hole-transporting material used in the HTL 140.1 and the first phosphorescent LEL 140.2, as long as it has a triplet energy higher than that of the phosphorescent dopant in the first phosphorescent LEL 140.2. In some cases, the host in the first spacer 140.3 may also include an electron-transporting material (it will be discussed thereafter), as long as it has a triplet energy higher than that of the phosphorescent dopant in the first phosphorescent LEL 140.2.

Triplet energy is conveniently measured by any of several means, as discussed for instance in Murov, Carmichael, and Hug, Handbook of Photochemistry, 2nd ed. (Marcel Dekker, New York, 1993).

The triplet state of a compound can also be calculated. The triplet state energy for a molecule is obtained as the difference between the ground state energy (E(gs)) of the molecule and the energy of the lowest triplet state (E(ts)) of the molecule, both given in eV. These energies are obtained using the B3LYP method as implemented in the Gaussian 98 (Gaussian, Inc., Pittsburgh, Pa.) computer program. The basis set for use with the B3LYP method is defined as follows: MIDI! for all atoms for which MIDI! is defined, 6-31G* for all atoms defined in 6-31G* but not in MIDI!, and either the LACV3P or the LANL2DZ basis set and pseudopotential for atoms not defined in MIDI! or 6-31G*, with LACV3P being the preferred method. For any remaining atoms, any published basis set and pseudopotential may be used. MIDI!, 6-31G* and LANL2DZ are used as implemented in the Gaussian 98 computer code and LACV3P is used as implemented in the Jaguar 4.1 (Schrodinger, Inc., Portland Oreg.) computer code. The energy of each state is computed at the minimum-energy geometry for that state. The difference in energy between the two states is further modified by equation (1) to give the triplet state energy (E(t)):

E(t)=0.84*(E(ts)−E(gs))+0.35 (eq. 1).

For polymeric or oligomeric materials, it is sufficient to compute the triplet energy over a monomer or oligomer of sufficient size so that additional units do not substantially change the computed triplet energy.

The calculated values for the triplet state energy of a given compound may typically show some deviation from the experimental values. Thus, the calculations should be used only as a rough guide in the selection of appropriate materials.

The triplet energies of materials used in the first spacer 140.3 are important. Also, the thickness of the first spacer 140.3 is critical to facilitate harvesting of triplet excitons from the fluorescent blue LEL 150 (as defined below) to the first phosphorescent LEL 140.2. The first spacer 140.3 is preferably thick enough to prevent singlet exciton transfer via Förster mechanism, i.e. the first spacer 140.3 has a thickness larger than the Förster radius (˜3 nm) (U.S. Patent Application Publication No. 2006/0279203 A1). The first spacer 140.3 is also preferably thin enough to allow the triplet excitons to reach the phosphorescent LEL. In preferred embodiments the thickness of the first spacer 140.3 is in the range of from 3 nm to 20 nm. However, in some cases, the thickness of the first spacer 140.3 can be zero in order to conveniently adjust color gamut. Therefore, in considering different cases, the thickness of the first spacer 140.3 (when present) is in the range of from 0.5 to 20 nm, preferably, in the range of from 1 to 15 nm. The fluorescent blue LEL 150 includes at least one host and at least one fluorescent blue dopant. The host may be a hole-transporting material as defined above, as long as the triplet energy of the hole-transporting material is higher than that of the phosphorescent dopants for use in the phosphorescent LELs in the device. The host may be an electron-transporting material as defined below, as long as the triplet energy of the electron-transporting material is higher than that of the phosphorescent dopants for use in the phosphorescent LELs in the device. There is at least one fluorescent blue dopant in the fluorescent blue LEL 150. The blue dopant is typically chosen from highly fluorescent dyes, e.g., transition metal complexes as described in WO 98/55561 A1, WO 00/18851 A1, WO 00/57676 A1, and WO 00/70655. Useful fluorescent blue dopants include, but are not limited to, derivatives of anthracene, tetracene, xanthene, perylene, phenylene, and fluorine. Useful fluorescent blue dopants also include, but are not limited to, dicyanomethylenepyran compounds, thiopyran compounds, polymethine compounds, pyrylium and thiapyrylium compounds, arylpyrene compounds, arylenevinylene compounds, periflanthene derivatives, indenoperylene derivatives, bis(azinyl)amine boron compounds, bis(azinyl)methane boron compounds, distryrylbenzene derivatives, distyrylbiphenyl derivatives, and carbostyryl compounds. Preferred fluorescent blue dopants may be found in Chen, Shi, and Tang, “Recent Developments in Molecular Organic Electroluminescent Materials,” Macromol. Symp. 125, 1 (1997) and the references cited therein; Hung and Chen, “Recent Progress of Molecular Organic Electroluminescent Materials and Devices,” Mat. Sci. and Eng. R39, 143 (2002) and the references cited therein.

Illustrative examples of useful fluorescent blue dopants include, but are not limited to, the following:

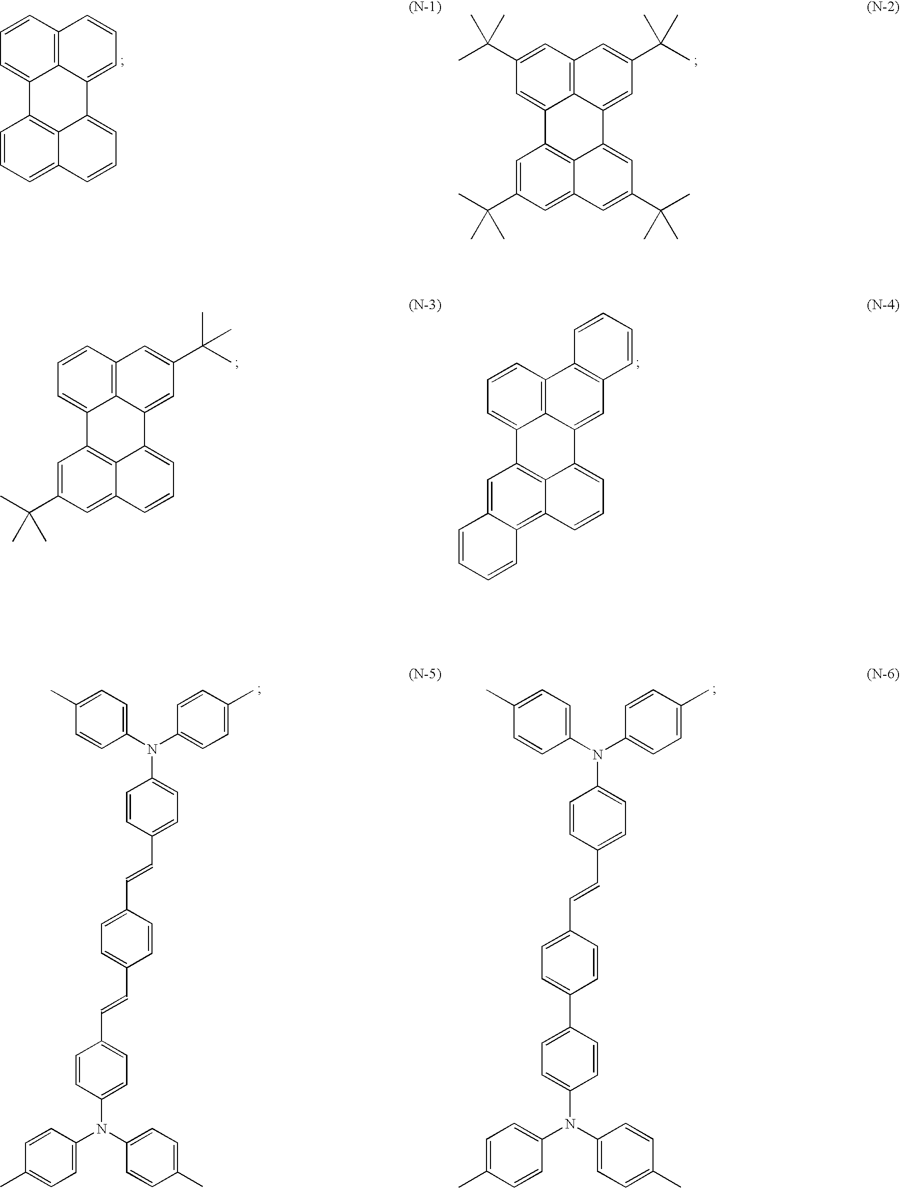

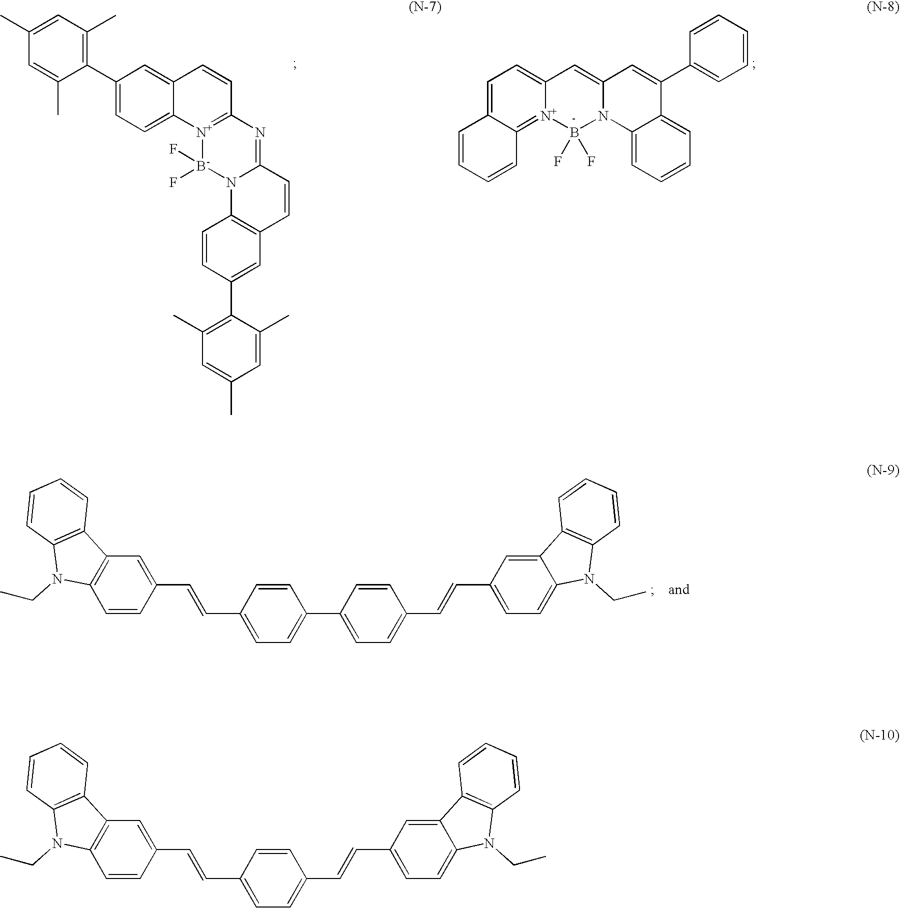

Of these, perylene derivatives (such as N-2), bis(azinyl)amine boron compounds (such as N-7) and distyrylbiphenyl derivatives (such as N-6) are preferred as blue fluorescent materials.

The dopant in the fluorescent blue LEL 150 is typically incorporated at 0.01 to 20% by volume of the LEL. The thickness of the fluorescent blue LEL 150 is in the range of from 1 nm to 80 nm, preferably, in the range of from 5 nm to 40 nm.

The material for use in the second spacer 160.1 should have higher triplet energy than that of the phosphorescent dopant in the second phosphorescent LEL. The second spacer 160.1 may contain at least one hole-transporting material as defined above. The second spacer 160.1 may contain at least one electron-transporting material such as benzazole, phenanthroline, 1,3,4-oxadiazole, triazole, triazine, or triarylborane.

A preferred class of benzazoles is described by Shi et al. in U.S. Pat. Nos. 5,645,948 and 5,766,779. Such compounds are represented by structural formula (O):

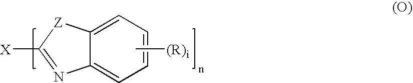

In formula (O), n is selected from 2 to 8 and i is selected from 1-5;

Z is independently O, NR or S;

R is individually hydrogen; alkyl of from 1 to 24 carbon atoms, for example, propyl, t-butyl, heptyl, and the like; aryl or hetero-atom substituted aryl of from 5 to 20 carbon atoms, for example, phenyl and naphthyl, furyl, thienyl, pyridyl, quinolinyl and other heterocyclic systems; or halo such as chloro, fluoro; or atoms necessary to complete a fused aromatic ring; and

X is a linkage unit consisting of carbon, alkyl, aryl, substituted alkyl, or substituted aryl, which conjugately or unconjugately connects the multiple benzazoles together.

An example of a useful benzazole is 2,2′,2″-(1,3,5-phenylene)tris[1-phenyl-1H-benzimidazole] (TPBI) represented by a formula (O-1) shown below:

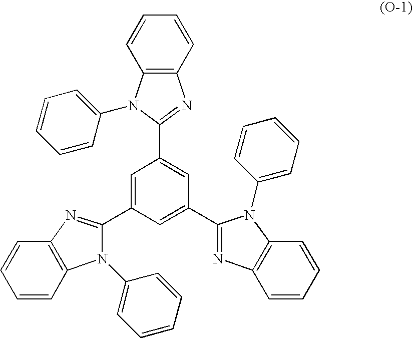

Another suitable class of the electron-transporting materials includes various substituted phenanthrolines as represented by formula (P):

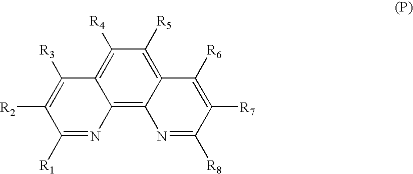

In formula (P), R₁-R₈ are independently hydrogen, alkyl group, aryl or substituted aryl group, and at least one of R₁-R₈ is aryl group or substituted aryl group.

Examples of suitable materials are 2,9-dimethyl-4,7-diphenyl-phenanthroline (BCP) (see formula (P-1)) and 4,7-diphenyl-1,10-phenanthroline (Bphen) (see formula (P-2)).

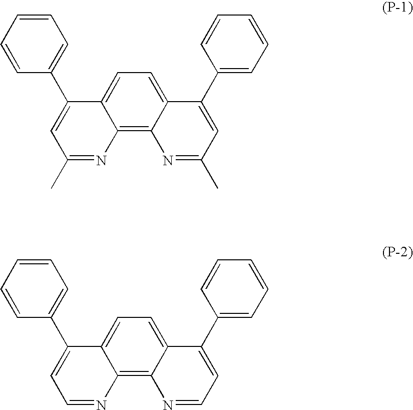

The triarylboranes that function as the electron-transporting material in the second spacer 160.1 may be selected from compounds having the chemical formula (Q):

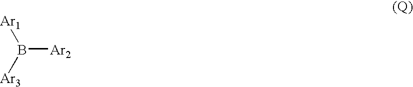

wherein,

Ar₁ to Ar₃ are independently an aromatic hydrocarbocyclic group or an aromatic heterocyclic group which may have a substitutent. It is preferable that compounds having the above structure are selected from formula (Q-1):

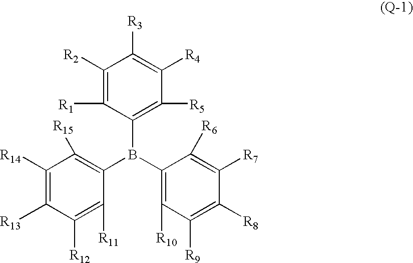

wherein R₁-R₁₅ are independently hydrogen, fluoro, cyano, trifluoromethyl, sulfonyl, alkyl, aryl or substituted aryl group.

Specific representative embodiments of the triarylboranes include:

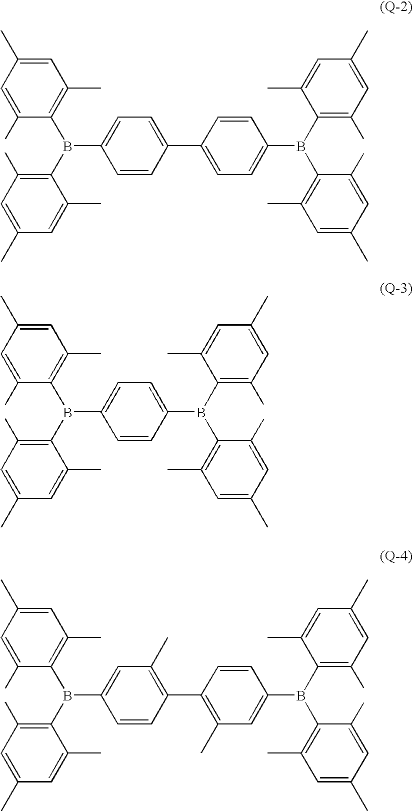

The electron-transporting material in the second spacer 160.1 may be selected from substituted 1,3,4-oxadiazoles of formula (R):

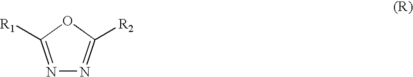

wherein R₁ and R₂ are individually hydrogen; alkyl of from 1 to 24 carbon atoms, for example, propyl, t-butyl, heptyl, and the like; aryl or hetero-atom substituted aryl of from 5 to 20 carbon atoms, for example, phenyl and naphthyl, furyl, thienyl, pyridyl, quinolinyl and other heterocyclic systems; or halo such as chloro, fluoro; or atoms necessary to complete a fused aromatic ring.

Illustrative of the useful substituted oxadiazoles are the following:

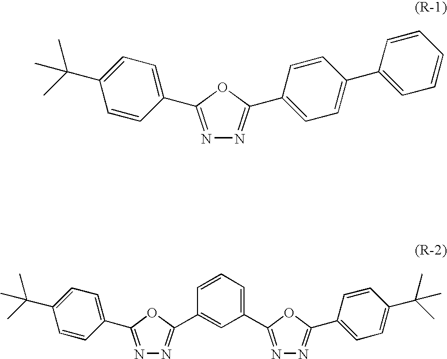

The electron-transporting material in the second spacer 160.1 may also be selected from substituted 1,2,4-triazoles according to formula (S):

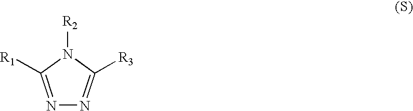

wherein R₁, R₂ and R₃ are independently hydrogen, alkyl group, aryl or substituted aryl group, and at least one of R₁-R₃ is aryl group or substituted aryl group. An example of a useful triazole is 3-phenyl-4-(1-naphtyl)-5-phenyl-1,2,4-triazole represented by formula (S-1):

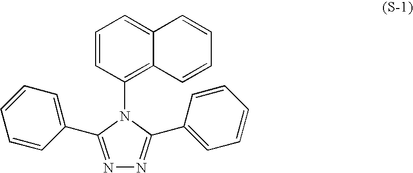

The electron-transporting material in the second spacer 160.1 may also be selected from substituted 1,3,5-triazines. Examples of suitable materials are:
2,4,6-tris(diphenylamino)-1,3,5-triazine;
2,4,6-tricarbazolo-1,3,5-triazine;
2,4,6-tris(N-phenyl-2-naphthylamino)-1,3,5-triazine;
2,4,6-tris(N-phenyl-1-naphthylamino)-1,3,5-triazine;
4,4′,6,6′-tetraphenyl-2,2′-bi-1,3,5-triazine;
2,4,6-tris([1,1′:3′,1″-terphenyl]-5′-yl)-1,3,5-triazine.

Some metal chelated oxinoid compounds having high triplet energy, such as aluminum(III)bis(2-methyl-8-hydroxyquinoline)-4-phenylphenolate (BAlq) and its derivatives, can also be useful as an electron-transporting material for use in the second spacer 160.1 and in the other layers.

The triplet energies of the electron-transporting materials used in the second spacer 160.1 are important. Also, the thickness of the second spacer 160.1 is critical to facilitate harvesting of triplet excitons from a fluorescent blue LEL 150 to the second phosphorescent LEL 160.2 (as defined below). The second spacer 160.1 is preferably thick enough to prevent singlet exciton transfer via Förster mechanism, i.e. the second spacer 160.1 has a thickness larger than the Förster radius (˜3 nm). The second spacer 160.1 is also preferably thin enough to allow the triplet excitons to reach the phosphorescent LEL. In preferred embodiments the thickness of the second spacer 160.1 is in the range of from 3 nm to 20 nm. However, in some cases, the thickness of the second spacer 160.1 can be zero in order to conveniently adjust color gamut. Therefore, in considering different cases, the thickness of the second spacer 160.1 (when present) is in the range of from 0.5 to 20 nm, preferably, in the range of from 1 to 15 nm. The second phosphorescent LEL 160.2 in the ETL region includes a host and at least one phosphorescent dopant.

A suitable host in the second phosphorescent LEL 160.2 should also be selected so that transfer of a triplet exciton can occur efficiently from the host to the phosphorescent dopant(s) but cannot occur efficiently from the phosphorescent dopant(s) to the host. Therefore, it is highly desirable that the triplet energy of the host be higher than the triplet energy of the phosphorescent dopant. Generally speaking, a large triplet energy implies a large optical band gap. However, the band gap of the host should not be chosen so large as to cause an unacceptable barrier to injection of electrons into the fluorescent blue LEL and an unacceptable increase in the drive voltage of the OLED. The host in the second phosphorescent LEL 160.2 includes the aforementioned electron-transporting material used for the second spacer 160.1. The host used in the second phosphorescent LEL 160.2 can be the same as or different from the electron-transporting material used in the second spacer 160.1.

Suitable phosphorescent dopants for use in the second phosphorescent LEL 160.2 can be selected from the phosphorescent materials for use in the first phosphorescent LEL 140.2. The phosphorescent dopant in the second phosphorescent light-emitting layer is selected from green and red phosphorescent materials. However, in order to achieve a white emission, the phosphorescent dopant for use in the second phosphorescent LEL 160.2 is preferably different from that in the first phosphorescent LEL 140.2. For example, if a red phosphorescent dopant is used in the first phosphorescent LEL 140.2, a green phosphorescent dopant should be used in the second phosphorescent LEL 160.2.

The phosphorescent dopant in the second phosphorescent LEL 160.2 is typically present in an amount of from 1 to 20% by volume of the LEL, and conveniently from 2 to 8% by volume of the LEL. In some embodiments, the phosphorescent dopant(s) may be attached to one or more host materials. Furthermore, the host materials may be polymers.

The thickness of the second phosphorescent LEL 160.2 is greater than 0.5 nm, preferably, in the range of from 1.0 nm to 40 nm.

The ETL 160.3 contains at least one electron-transporting material. The electron-transporting material used in the ETL 160.3 is selected from the electron-transporting materials discussed in the second spacer 160.1 and the second phosphorescent LEL 160.2. The electron-transporting material used in the ETL 160.3 can be the same as or different from the electron-transporting material(s) used in the second spacer 160.1 and the second phosphorescent LEL 160.2.

However, in some cases, it is not a requirement that the electron-transporting material used in the ETL 160.3 should have a triplet energy higher than that of the phosphorescent dopant in the second phosphorescent LEL 160.2. Therefore, in addition to the aforementioned electron-transporting materials, the electron-transporting materials for use in the ETL 160.3 may also be selected from, but are not limited to, chelated oxinoid compounds, anthracene derivatives, pyridine-based materials, imidazoles, oxazoles, thiazoles and their derivatives, polybenzobisazoles, cyano-containing polymers and perfluorinated materials.

For example, the electron-transporting materials for use in the ETL 160.3 may be a metal chelated oxinoid compound including chelates of oxine itself (also commonly referred to as 8-quinolinol or 8-hydroxyquinoline). Exemplary of contemplated oxinoid compounds are those satisfying structural Formula (T)

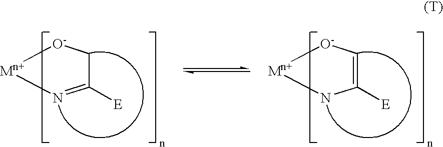

wherein:

M represents a metal;

n is an integer of from 1 to 4; and

Z independently in each occurrence represents the atoms completing a nucleus having at least two fused aromatic rings.

Particularly useful aluminum or gallium complex host materials are represented by Formula (T-a).

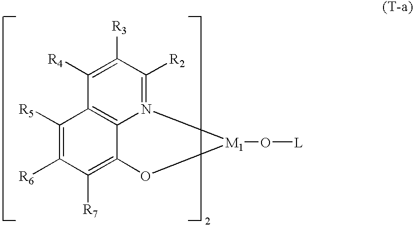

In Formula (T-a), M₁ represents Al or Ga. R₂-R₇ represent hydrogen or an independently selected substitutent. Desirably, R₂ represents an electron-donating group. Suitably, R₃ and R₄ each independently represent hydrogen or an electron donating substitutent. A preferred electron-donating group is alkyl such as methyl. Preferably, R₅, R₆, and R₇ each independently represent hydrogen or an electron-accepting group. Adjacent substitutents, R₂-R₇, may combine to form a ring group. L is an aromatic moiety linked to the aluminum by oxygen, which may be substituted with substitutent groups such that L has from 6 to 30 carbon atoms.

Illustrative of useful chelated oxinoid compounds for use in the ETL 160.3 are the following:
T-1: Aluminum trisoxine[alias,tris(8-quinolinolato)aluminum(III) or Alq or Alq3];
T-2: Magnesium bisoxine[alias,bis(8-quinolinolato)magnesium(II)];
T-3: Bis[benzo{f}-8-quinolinolato]zinc(II);
T-4: Bis(2-methyl-8-quinolinolato)aluminum(III)-μ-oxo-bis(2-methyl-8-quinolinolato)aluminum(III);
T-5: Indium trisoxine[alias,tris(8-quinolinolato)indium];
T-6: Aluminum tris(5-methyloxine)[alias,tris(5-methyl-8-quinolinolato)aluminum(III)];
T-7: Lithium oxine[alias,(8-quinolinolato)lithium(I)];
T-8: Gallium oxine[alias,tris(8-quinolinolato)gallium(III)]; and
T-9: Zirconium oxine[alias,tetra(8-quinolinolato)zirconium(IV)]
T-a-1: Aluminum(III)bis(2-methyl-8-hydroxyquinoline)-4-phenylphenolate[alias,Balq].

As another example, anthracene derivatives according to formula (U) as useful in the ETL 160.3:

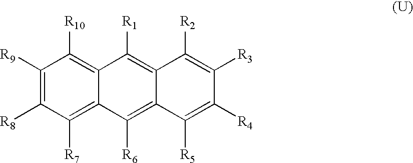

wherein R₁-R₁₀ are independently chosen from hydrogen, alkyl groups for 1-24 carbon atoms or aromatic groups from 1-24 carbon atoms. Particularly preferred are compounds where R₁ and R₆ are phenyl, biphenyl or napthyl, R₃ is phenyl, substituted phenyl or napthyl and R₂, R₄, R₅, R₇-R₁₀ are all hydrogen. Some illustrative examples of suitable anthracenes are:

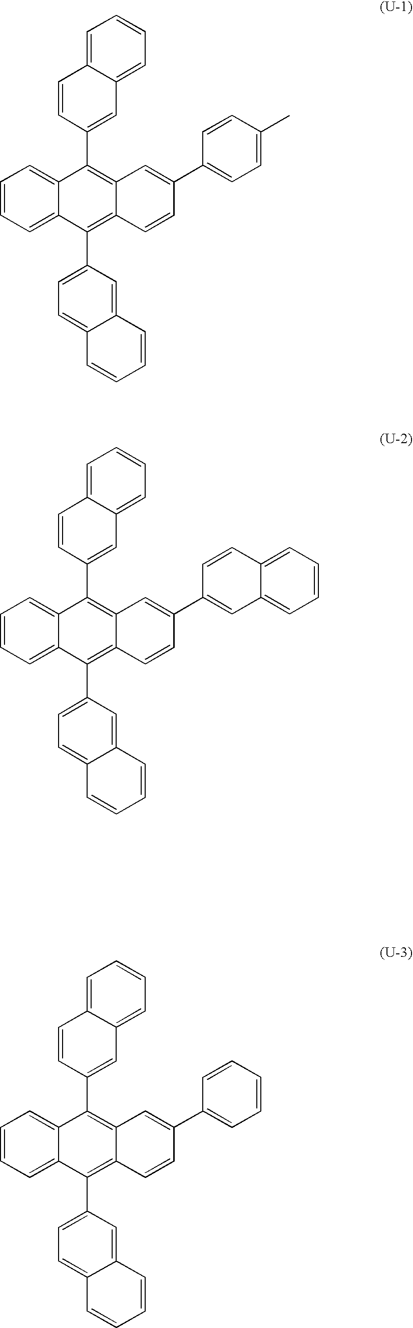

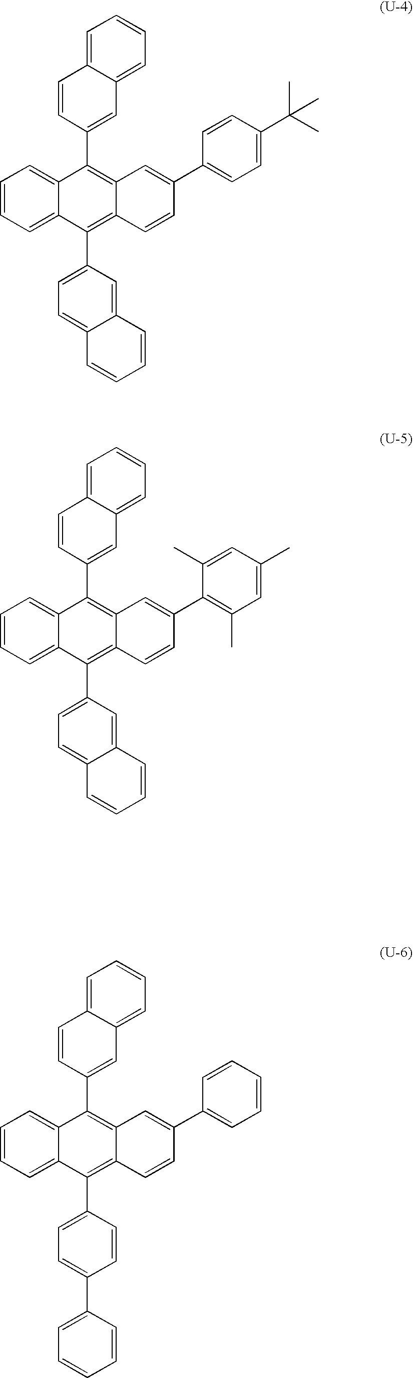

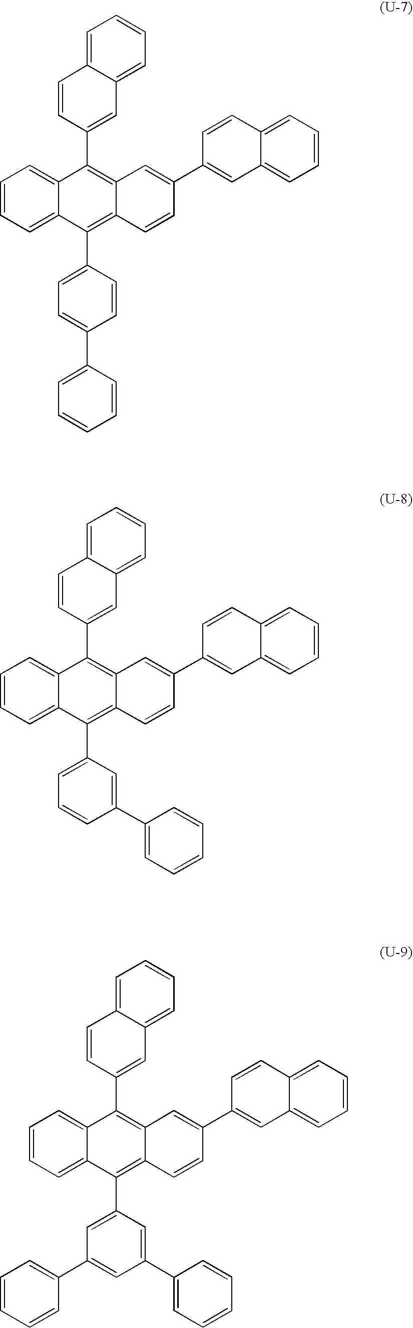

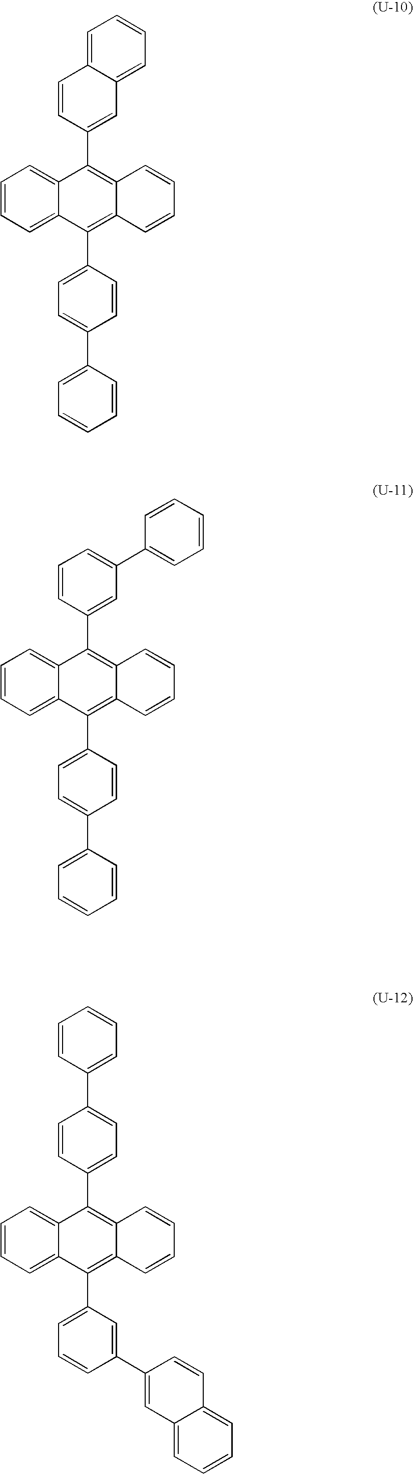

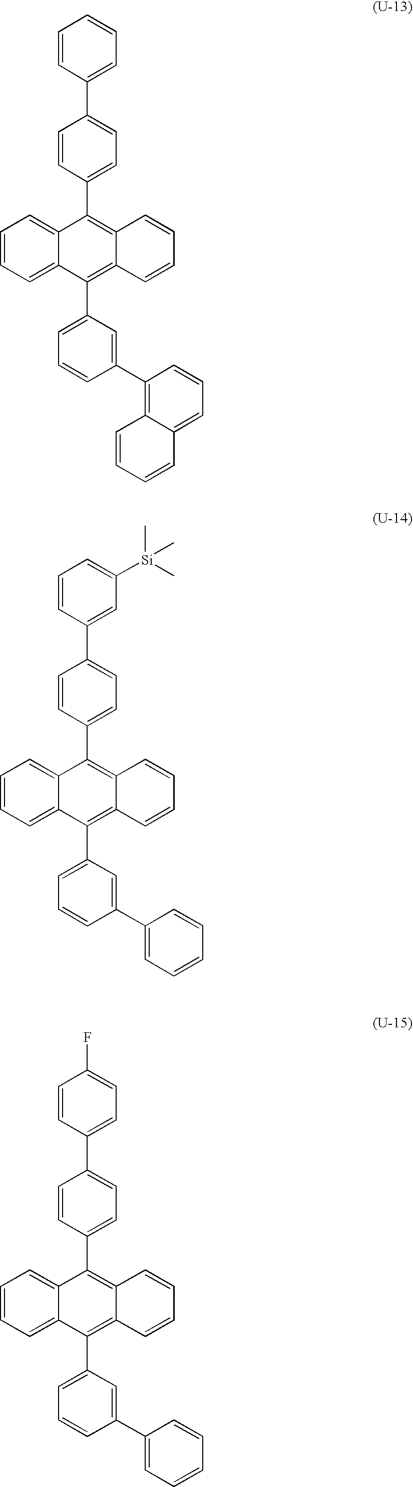

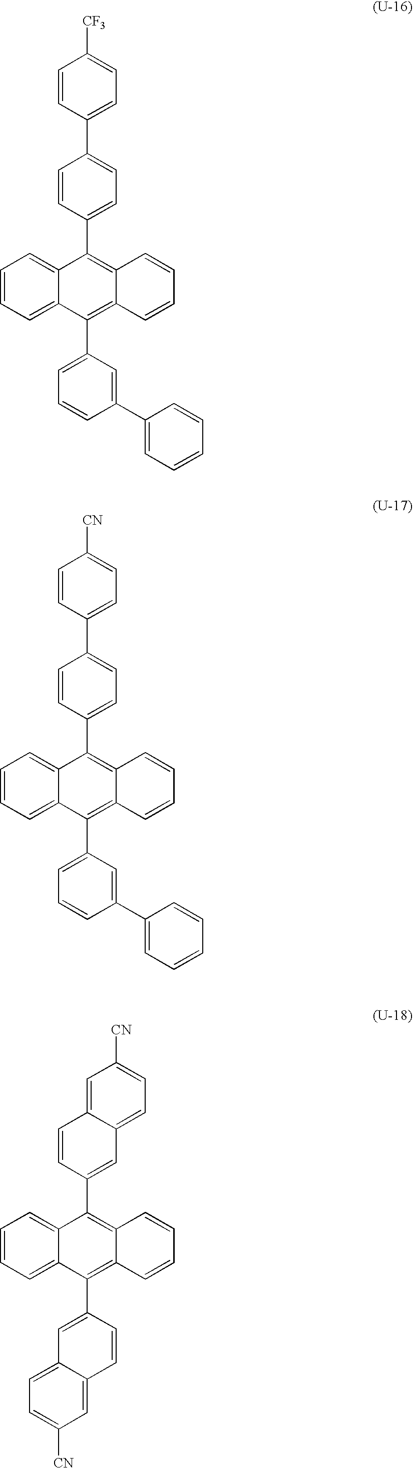

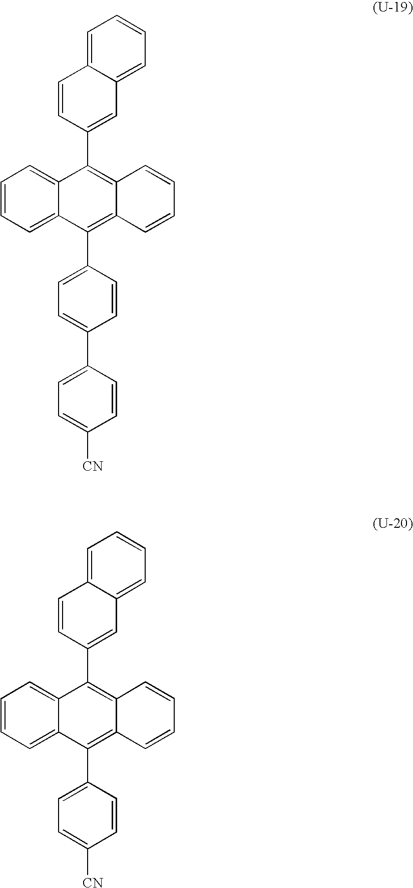

The thickness of the ETL 160.3 is in the range of from 5 nm to 200 nm, preferably, in the range of from 10 nm to 150 nm.

EIL 170 may be an n-type doped layer containing at least one electron-transporting material as a host and at least one n-type dopant. The dopant is capable of reducing the host by charge transfer. The term “n-type doped layer” means that this layer has semiconducting properties after doping, and the electrical current through this layer is substantially carried by the electrons.

The host in EIL 170 is an electron-transporting material capable of supporting electron injection and electron transport. The electron-transporting material can be selected from the electron-transporting materials for use in the ETL region as defined above.

The n-type dopant in the n-type doped EIL 170 is selected from alkali metals, alkali metal compounds, alkaline earth metals, or alkaline earth metal compounds, or combinations thereof. The term “metal compounds” includes organometallic complexes, metal-organic salts, and inorganic salts, oxides and halides. Among the class of metal-containing n-type dopants, Li, Na, K, Rb, Cs, Mg, Ca, Sr, Ba, La, Ce, Sm, Eu, Tb, Dy, or Yb, and their compounds, are particularly useful. The materials used as the n-type dopants in the n-type doped EIL 170 also include organic reducing agents with strong electron-donating properties. By “strong electron-donating properties” it is meant that the organic dopant should be able to donate at least some electronic charge to the host to form a charge-transfer complex with the host. Nonlimiting examples of organic molecules include bis(ethylenedithio)-tetrathiafulvalene (BEDT-TTF), tetrathiafulvalene (TTF), and their derivatives. In the case of polymeric hosts, the dopant is any of the above or also a material molecularly dispersed or copolymerized with the host as a minor component. Preferably, the n-type dopant in the n-type doped EIL 170 includes Li, Na, K, Rb, Cs, Mg, Ca, Sr, Ba, La, Ce, Nd, Sm, Eu, Tb, Dy, or Yb, or combinations thereof. The n-type doped concentration is preferably in the range of 0.01-20% by volume of this layer. The thickness of the n-type doped EIL 170 is typically less than 200 nm, and preferably in the range of less than 150 nm.

EIL 170 may also include alkaline metal complexes or alkaline earth metal complexes. Wherein, the metal complex in the electron-injecting layer includes a cyclometallated complex represented by Formula (X)

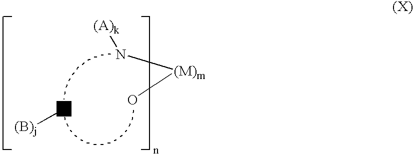

wherein:

Z and the dashed arc represent two or three atoms and the bonds necessary to complete a 5- or 6-membered ring with M;

each A represents H or a substitutent and each B represents an independently selected substitutent on the Z atoms, provided that two or more substitutents may combine to form a fused ring or a fused ring system;

j is 0-3 and k is 1 or 2;

M represents an alkali metal or an alkaline earth metal; and

m and n are independently selected integers selected to provide a neutral charge on the complex.

Illustrative examples of useful electron-injecting materials include, but are not limited to, the following:

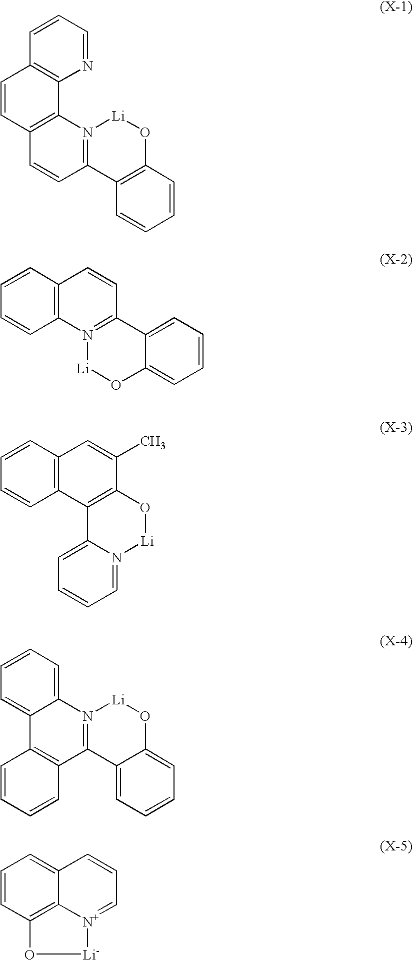

The thickness of EIL 170 including the alkaline metal complexes or alkaline earth metal complexes is typically less than 20 nm, and preferably in the range of less than 5 nm.

The organic materials in the OLEDs mentioned above are suitably deposited through a vapor-phase method such as thermal evaporation, but may also be deposited from a fluid, for example, from a solvent with an optional binder to improve film formation. If the material is a polymer, solvent deposition is useful but other methods are used, such as sputtering or thermal transfer from a donor sheet. The material to be deposited by thermal evaporation is vaporized from an evaporation “boat” often including a tantalum material, e.g., as described in U.S. Pat. No. 6,237,529, or is first coated onto a donor sheet and then sublimed in closer proximity to the substrate. Layers with a mixture of materials can utilize separate evaporation boats for the materials or the materials are premixed and coated from a single boat or donor sheet. For full color display, the pixelation of LELs may be needed. This pixelated deposition of LELs is achieved using shadow masks, integral shadow masks, U.S. Pat. No. 5,294,870, spatially defined thermal dye transfer from a donor sheet, U.S. Pat. Nos. 5,688,551, 5,851,709, and 6,066,357, and inkjet method, U.S. Pat. No. 6,066,357.

When light emission is viewed solely through the anode, the cathode 180 includes nearly any conductive material. Desirable materials have effective film-forming properties to ensure effective contact with the underlying organic layer, promote electron injection at low voltage, and have effective stability. Useful cathode materials often contain a low work function metal (<4.0 eV) or metal alloy. One preferred cathode material includes a Mg:Ag alloy as described in U.S. Pat. No. 4,885,221. Another suitable class of cathode materials includes bilayers including a thin inorganic EIL in contact with an organic layer (e.g., organic EIL or ETL), which is capped with a thicker layer of a conductive metal. Here, the inorganic EIL preferably includes a low work function metal or metal salt and, if so, the thicker capping layer does not need to have a low work function. One such cathode includes a thin layer of LiF followed by a thicker layer of Al as described in U.S. Pat. No. 5,677,572. Other useful cathode material sets include, but are not limited to, those disclosed in U.S. Pat. Nos. 5,059,861, 5,059,862, and 6,140,763.

When light emission is viewed through the cathode, cathode 180 should be transparent or nearly transparent. For such applications, metals should be thin or one should use transparent conductive oxides, or include these materials. Optically transparent cathodes have been described in more detail in U.S. Pat. Nos. 4,885,211, 5,247,190, 5,703,436, 5,608,287, 5,837,391, 5,677,572, 5,776,622, 5,776,623, 5,714,838, 5,969,474, 5,739,545, 5,981,306, 6,137,223, 6,140,763, 6,172,459, 6,278,236, 6,284,393, and EP 1 076 368. Cathode materials are typically deposited by thermal evaporation, electron beam evaporation, ion sputtering, or chemical vapor deposition. When needed, patterning is achieved through many well known methods including, but not limited to, through-mask deposition, integral shadow masking, for example as described in U.S. Pat. No. 5,276,380 and EP 0 732 868, laser ablation, and selective chemical vapor deposition.

OLED 100 is typically provided over a supporting substrate where either the anode 120 or cathode 180 can be in contact with the substrate. The electrode in contact with the substrate is conveniently referred to as the bottom electrode. Conventionally, the bottom electrode is the anode 120, but this invention is not limited to that configuration. The substrate can either be light transmissive or opaque, depending on the intended direction of light emission. The light transmissive property is desirable for viewing the EL emission through the substrate. Transparent glass or plastic is commonly employed in such cases. The substrate can be a complex structure comprising multiple layers of materials. This is typically the case for active matrix substrates wherein TFTs are provided below the OLED layers. It is still necessary that the substrate, at least in the emissive pixelated areas, be comprised of largely transparent materials such as glass or polymers. For applications where the EL emission is viewed through the top electrode, the transmissive characteristic of the bottom support is immaterial, and therefore the substrate can be light transmissive, light absorbing or light reflective. Substrates for use in this case include, but are not limited to, glass, plastic, semiconductor materials such as silicon, ceramics, and circuit board materials. Again, the substrate can be a complex structure comprising multiple layers of materials such as found in active matrix TFT designs. It is necessary to provide in these device configurations a light-transparent top electrode.

OLEDs of this invention can employ various well-known optical effects in order to enhance their emissive properties if desired. This includes optimizing layer thicknesses to yield maximum light transmission, providing dielectric mirror structures, replacing reflective electrodes with light-absorbing electrodes, providing anti-glare or anti-reflection coatings over the display, providing a polarizing medium over the display, or providing colored, neutral density, or color-conversion filters over the display. Filters, polarizers, and anti-glare or anti-reflection coatings may be specifically provided over the OLED or as part of the OLED.

Most OLEDs are sensitive to moisture or oxygen, or both, so they are commonly sealed in an inert atmosphere such as nitrogen or argon, along with a desiccant such as alumina, bauxite, calcium sulfate, clays, silica gel, zeolites, alkaline metal oxides, alkaline earth metal oxides, sulfates, or metal halides and perchlorates. Methods for encapsulation and desiccation include, but are not limited to, those described in U.S. Pat. No. 6,226,890. In addition, barrier layers such as SiOₓ, Teflon, and alternating inorganic/polymeric layers are known in the art for encapsulation.

In accordance with this disclosure, white light is that light that is perceived by a user as having a white color, or light that has an emission spectrum sufficient to be used in combination with color filters to produce a practical full color display. For low power consumption, it is often advantageous for the chromaticity of the white light-emitting OLED to be close to CIE D65, i.e., CIE x=0.31 and CIE y=0.33. This is particularly the case for so-called RGBW displays having red, green, blue, and white pixels. Although CIEx, CIEy coordinates of about 0.31, 0.33 are ideal in some circumstances, the actual coordinates can vary significantly and still be very useful. To produce a white emitting device, ideally the hybrid device of the invention would comprise a blue fluorescent emitter and proper proportions of green and red phosphorescent emitters, or other color combinations suitable to make white emission. However, hybrid devices having non-white emission may also be useful by themselves. Hybrid elements of the invention having non-white emission may also be combined with additional light-emitting elements in series in a stacked OLED. Herein, “blue light” refers to light whose maximum emission peak has a wavelength of between 400-500 nm, “green light” refers to light whose maximum emission peak has a wavelength of between 500-600 nm and “red light” refers to light whose maximum emission peak has a wavelength of between 600-700 nm. It is possible that each of these colors may additionally contain smaller amounts of light with emissive peaks outside the indicated region.

The aforementioned OLEDs prepared in accordance with the present invention are useful for various display applications. OLED displays or the other electronic devices can include a plurality of the OLEDs as described above.

### EXAMPLES

The following examples are presented for a further understanding of the present invention. During the fabrication of OLEDs, the thickness of the organic layers and the doping concentrations were controlled and measured in situ using calibrated thickness monitors (INFICON IC/5 Deposition Controller, made by Inficon Inc., Syracuse, N.Y.). The EL characteristics of all the fabricated devices were evaluated using a constant current source (KEITHLEY 2400 SourceMeter, made by Keithley Instruments, Inc., Cleveland, Ohio) and a photometer (PHOTO RESEARCH SpectraScan PR 650, made by Photo Research, Inc., Chatsworth, Calif.) at room temperature. The color was reported using Commission Internationale de l'Eclairage (CIE) coordinates. The explanative examples below help to illustrative the principles and advantages of the invention.

### Examples 1-2 (Explanative)

The preparation of a conventional OLED (Device 1) is as follows: A ˜1.1 mm thick glass substrate coated with a transparent ITO conductive layer was cleaned and dried using a commercial glass scrubber tool. The thickness of ITO is about 22 nm and the sheet resistance of the ITO is about 68 Ω/square. The ITO surface was subsequently treated with oxidative plasma to condition the surface as an anode. A layer of CFx, 1 nm thick, was deposited on the clean ITO surface as the anode buffer layer by decomposing CHF₃ gas in an RF plasma treatment chamber. The substrate was then transferred into a vacuum deposition chamber for deposition of all other layers on top of the substrate. The following layers were deposited in the following sequence by evaporation from a heated boat under a vacuum of approximately 10⁻⁶ Torr:

a) an HIL, 10 nm thick, including hexaazatriphenylene hexacarbonitrile (HAT-CN);

b) a hole-transporting region, 85 nm thick, including N,N′-di-1-naphthyl-N,N′-diphenyl-4,4′-diaminobiphenyl (NPB);

c) a fluorescent blue LEL, 20 nm thick, including formula (O-1) as a host and formula (N-6) as a dopant. The doping concentration is about 7 volume %.

d.1) a first ETL, 10 nm thick, including formula (P-2);

d.3) a second ETL, 25 nm thick, including formula (U-3);

e) an EIL, 2 nm thick, including formula (X-1); and

f) cathode: approximately 150 nm thick, including Al.

After the deposition of these layers, the device was transferred from the deposition chamber into a dry box (made by VAC Vacuum Atmosphere Company, Hawthorne, Calif.) for encapsulation. The OLED has an emission area of 10 mm².

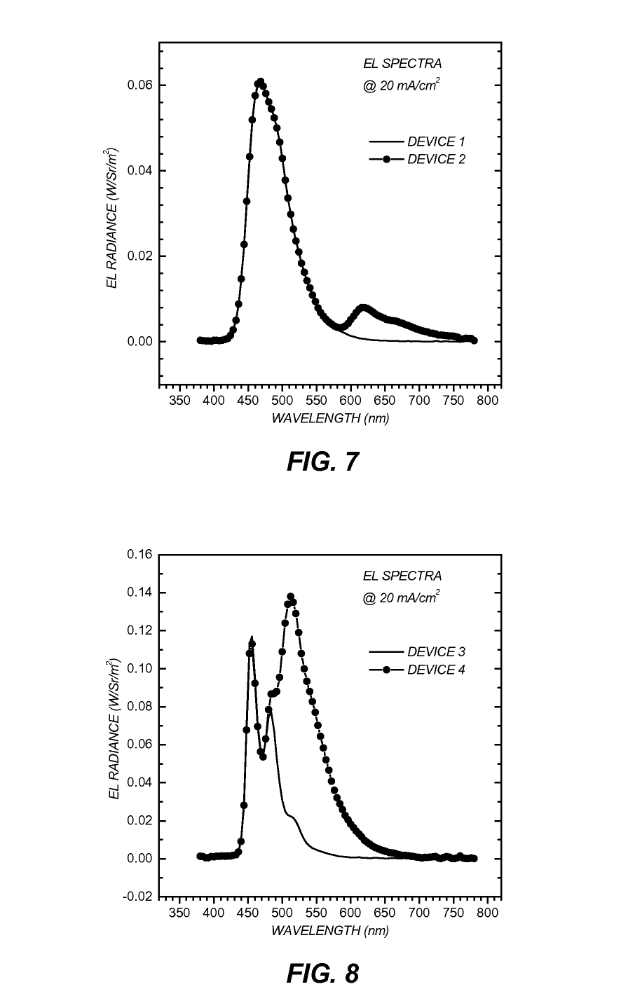

Device 1 is denoted as: ITO/10 nm HAT-CN/85 nm NPB/20 nm (O-1):7 vol % (N-6)/10 nm (P-2)/25 nm (U-3)/2 nm (X-1)/150 nm Al. The EL performance of the device is summarized in Table 1, and its EL spectrum is shown in FIG. 7.

Another OLED (Device 2) is fabricated with the same method and the same layer structure as Example 1, except that the hole-transporting region (“layer b” in Device 1) is divided into three sub-layers in sequence in Device 2:

b.1) an HTL, 60 nm thick, including NPB. The HTL is disposed in contact with the HIL in the device;

b.2) a first phosphorescent LEL, 20 nm thick, including NPB doped with about 4 vol % tris(1-phenylisoquinoline)iridium III) (Ir(piq)₃) which is a C,N-cyclometallated complex; and

b.3) a first spacer, 5 nm thick, including NPB. The first spacer is disposed in contact with the fluorescent blue LEL in the device.

Device 2 is denoted as: ITO/10 nm HAT-CN/60 nm NPB/20 nm NPB:4 vol % Ir(piq)₃/5 nm NPB/20 nm (O-1):7 vol % (N-6)/10 nm (P-2)/25 nm (U-3)/2 nm (X-1)/150 nm Al. The EL performance of the device is summarized in Table 1, and its EL spectrum is shown in FIG. 7.

As can be seen from FIG. 7, by inserting a phosphorescent LEL in the HTL region, Device 2 exhibits not only a fluorescent blue emission peak but also a phosphorescent red emission peak. The fluorescent emission intensity in Device 2 is the same as that in Device 1. This indicates that the phosphorescent red emission is due to utilization of the triplet excitons generated in the fluorescent blue LEL. Therefore, inserting a phosphorescent LEL in the hole-transporting region can indeed capture the otherwise wasted triplet excitons. As a result, both the power efficiency and the external quantum efficiency have been increased.

### Examples 3-4 (Explanative)

Another OLED (Device 3) was constructed in the same manner as Example 1. The Layer Structure is

a) an HIL, 10 nm thick, including HAT-CN;

b) an HTL, 75 nm thick, including NPB;

c) a first spacer, 4 nm thick, including 4,4′,4″-tris(carbazolyl)-triphenylamine (TCTA);

d) a fluorescent blue LEL, 10 nm thick, including 4,4′,4″-N,N-dicarbazole-biphenyl (CBP) as a host and formula (N-7) as a dopant. The doping concentration is about 1.7 vol %.

e) an electron-transporting region, 34 nm thick, including formula (P-2);

f) a second ETL, 15 nm thick, including formula (U-3);

g) an EIL, 2 nm thick, including formula (X-1); and

h) cathode: approximately 150 nm thick, including Al.

Device 3 is denoted as: ITO/10 nm HAT-CN/75 nm NPB/4 nm TCTA/10 nm CBP:1.7 vol % (N-7)/34 nm (P-2)/15 nm (U-3)/2 nm (X-1)/150 nm Al. The EL performance of the device is summarized in Table 1, and its EL spectrum is shown in FIG. 8.

Another OLED (Device 4) is fabricated with the same method and the same layer structure as Example 3, except that the electron-transporting region (“layer e” in Device 3) is divided into three sub-layers in sequence in Device 4:

e.1) a second spacer, 4 nm thick, including formula (P-2). The second spacer is disposed in contact with the fluorescent blue LEL in the device;

e.2) a second phosphorescent LEL, 10 nm thick, including formula (P-2) doped with about 5 vol % tris(2-phenylpyridine)iridium (Ir(ppy)₃) which is a C,N-cyclometallated complexes; and

e.3) a first ETL, 20 nm thick, including formula (P-2). The first ETL is disposed in contact with the second ETL in the device.

Device 4 is denoted as: ITO/10 nm HAT-CN/75 nm NPB/4 nm TCTA/10 nm CBP:1.7 vol % (N-7)/4 nm (P-2)/10 nm (P-2):5 vol % Ir(ppy)₃/20 nm (P-2)/15 nm (U-3)/2 nm (X-1)/150 nm Al. The EL performance of the device is summarized in Table 1, and its EL spectrum is shown in FIG. 8.

As can also be seen from FIG. 8, by inserting a phosphorescent LEL in the electron-transporting region, Device 4 exhibits not only a fluorescent blue emission peak but also a phosphorescent green emission peak. The fluorescent emission intensity in Device 4 is the same as that in Device 3. This indicates that the phosphorescent green emission is due to utilization of the triplet excitons generated in the fluorescent blue LEL. Therefore, inserting a phosphorescent LEL in the electron-transporting region can indeed capture the otherwise wasted triplet excitons. As a result, both the power efficiency and the external quantum efficiency have been increased.

TABLE 1

| Example(Type) | | | | | | | External |
|---|---|---|---|---|---|---|---|
| (EL measured | | | Luminous | | | Power | Quantum |
| @ RT and | Voltage | Luminance | Efficiency | CIE x | CIE y | Efficiency | Efficiency |
| 20 mA/cm²) | (V) | (cd/m²) | (cd/A) | (1931) | (1931) | (lm/W) | (%) |
| 1 (Explanative) | 4.7 | 866 | 4.3 | 0.144 | 0.223 | 2.4 | 2.7 |
| 2 (Explanative) | 4.1 | 946 | 4.8 | 0.180 | 0.230 | 3.0 | 3.3 |
| 3 (Explanative) | 4.5 | 702 | 3.5 | 0.138 | 0.142 | 2.0 | 3.1 |
| 4 (Explanative) | 4.4 | 4488 | 22.4 | 0.211 | 0.402 | 13.0 | 8.4 |

### Examples 5-7 (Comparative)

An OLED (Device 5) was constructed in the same manner as that of Example 1. The layer structure is:

a) an HIL, 10 nm thick, including HAT-CN;

b) an HTL, 75 nm thick, including NPB;

c.1) a first fluorescent blue LEL, 15 nm thick, including CBP doped with about 6 vol % of formula (N-6);

c.2) a first spacer, 4 nm thick, including CBP;

c.3) a first phosphorescent LEL, 8 nm thick, including CBP doped with about 4 vol % of Ir(piq)₃;

c.4) a second phosphorescent LEL, 12 nm thick, including CBP doped with about 5 vol % of Ir(ppy)₃;

c.5) a second spacer, 6 nm thick, including CBP;

c.6) a second fluorescent blue LEL, 10 nm thick, including CBP doped with about 6 vol % of formula (N-6);

d.1) a first ETL, 10 nm thick, including formula (P-2);

d.2) a second ETL, 10 nm thick, including formula (U-3);

e) an EIL, 2 nm thick, including formula (X-1); and

f) cathode: approximately 150 nm thick, including Al.

Device 5 is denoted as: ITO/10 nm HAT-CN/75 nm NPB/15 nm CBP:6 vol % (N-6)/4 nm CBP/8 nm CBP:4 vol % Ir(piq)₃/8 nm CBP:4 vol % Ir(ppy)₃/6 nm CBP/10 nm CBP:6 vol % (N-6)/10 nm (P-2)/10 nm (U-3)/2 nm (X-1)/150 nm Al. The EL performance of the device is summarized in Table 2.

Another OLED (Device 6) was fabricated with the same manner and the same layer structure as Device 5, except that the fluorescent blue dopant was changed as follows:

c.1) a first fluorescent blue LEL, 15 nm thick, including CBP doped with about 5 vol % of formula (N-9) (BCzVBi);

c.6) a second fluorescent blue LEL, 10 nm thick, including CBP doped with about 5 vol % of formula (N-9);

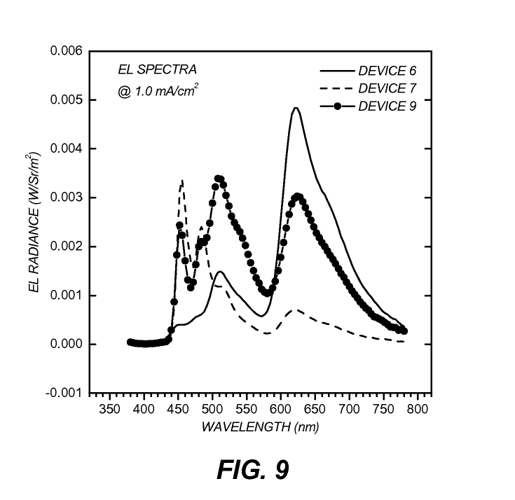

Device 6 is denoted as: ITO/10 nm HAT-CN/75 nm NPB/15 nm CBP:5 vol % (N-9)/4 nm CBP/8 nm CBP:4 vol % Ir(piq)₃/8 nm CBP:4 vol % Ir(ppy)₃/6 nm CBP/10 nm CBP:5 vol % (N-9)/10 nm (P-2)/10 nm (U-3)/2 nm (X-1)/150 nm Al. Device 6 is constructed as a reference according to the layer structure taught by Forrest et al. in U.S. Patent Application Publication No. 2006/0,279,203 A1 The EL performance of the device is summarized in Table 2, and its EL spectrum is shown in FIG. 9.

Another OLED (Device 7) was fabricated with the same manner and the same layer structure as Device 5, except that the fluorescent blue dopant was changed as follows:

c.1) a first fluorescent blue LEL, 15 nm thick, including CBP doped with about 1.7 vol % of formula (N-7);

c.6) a second fluorescent blue LEL, 10 nm thick, including CBP doped with about 5 vol % of formula (N-7);

Device 7 is denoted as: ITO/10 nm HAT-CN/75 nm NPB/15 nm CBP:1.7 vol % (N-7)/4 nm CBP/8 nm CBP:4 vol % Ir(piq)₃/8 nm CBP:4 vol % Ir(ppy)₃/6 nm CBP/10 nm CBP:1.7 vol % (N-7)/10 nm (P-2)/10 nm (U-3)/2 nm (X-1)/150 nm Al. The EL performance of the device is summarized in Table 2, and its EL spectrum is shown in FIG. 9.

Each of the Devices 5-7 has two fluorescent blue LELs. A portion of the triplet excitons generated in the first fluorescent blue LEL can be wasted in the HTL. Moreover, since there are 6 sub-layers using CBP material, the thick CBP layers can cause high drive voltage resulting in low power efficiency.

TABLE 2

| Example(Type) | | | | | | | External |
|---|---|---|---|---|---|---|---|
| (EL measured @ RT | | | Luminous | | | Power | Quantum |
| and | Voltage | Luminance | Efficiency | CIE x | CIE y | Efficiency | Efficiency |
| 1.0 mA/cm²) | (V) | (cd/m²) | (cd/A) | (1931) | (1931) | (lm/W) | (%) |
| 5 (Comparative) | 6.9 | 112 | 11.2 | 0.364 | 0.386 | 5.1 | 6.9 |
| 6 (Comparative) | 5.9 | 110 | 11.0 | 0.520 | 0.382 | 5.9 | 8.8 |
| 7 (Comparative) | 10.6 | 46 | 4.6 | 0.227 | 0.239 | 1.4 | 3.3 |
| 8 (Inventive) | 5.6 | 183 | 18.3 | 0.274 | 0.436 | 10.3 | 7.8 |
| 9 (Inventive) | 5.4 | 149 | 14.9 | 0.356 | 0.401 | 8.7 | 8.6 |
| 10 (Inventive) | 4.2 | 95 | 9.5 | 0.408 | 0.399 | 7.2 | 6.2 |
| 11 (Inventive) | 3.8 | 120 | 12.0 | 0.319 | 0.426 | 10.0 | 5.9 |
| 12 (Inventive) | 4.0 | 163 | 16.3 | 0.292 | 0.445 | 13 | 7.2 |

### Examples 8-12

An OLED (Device 8) was fabricated in accordance with the present invention. The fabrication method is the same as that of Example 1. The layer structure is as follows:

a) an HIL, 10 nm thick, including HAT-CN;

b.1) an HTL, 49 nm thick, including NPB;

b.2) a first phosphorescent LEL, 20 nm thick, including NPB (triplet energy=2.41) doped with about 4 vol % of Ir(piq)₃ (triplet energy=2.12);

b.3) a first spacer, 4 nm thick, including NPB;

c) a first fluorescent blue LEL, 10 nm thick, including CBP (triplet energy=2.67) doped with about 1.0 vol % of formula (N-7) (triplet energy=2.29);

d.1) a second spacer, 4 nm thick, including CBP;

d.2) a second phosphorescent LEL, 10 nm thick, including CBP doped with about 5 vol % of Ir(ppy)₃ (triplet energy=2.54);

e.1) a first ETL, 15 nm thick, including formula (P-2);

e.2) a second ETL, 15 nm thick, including formula (U-3);

f) an EIL, 2 nm thick, including formula (X-1); and

g) cathode: approximately 150 nm thick, including Al.

Device 8 is denoted as: ITO/10 nm HAT-CN/49 nm NPB/20 nm NPB:4 vol % Ir(piq)₃/4 nm NPB/10 nm CBP: 1.0 vol % (N-7)/4 nm CBP/10 nm CBP:5 vol % Ir(ppy)₃/15 nm (P-2)/15 nm (U-3)/2 nm (X-1)/150 nm Al. The EL performance of the device is summarized in Table 2.

Both Device 7 and Device 8 have the same fluorescent dopant (N-7) in the fluorescent blue LEL. However, in Device 8, a first phosphorescent LEL is formed in the hole-transporting region and only one fluorescent blue LEL is used in the device. Therefore, the drive voltage is reduced and the power efficiency is increased.

Another OLED (Device 9) was fabricated in accordance with the present invention. The fabrication method is the same as that of Example 1. The layer structure is as follows:

a) an HIL, 10 nm thick, including HAT-CN;

b.1) an HTL, 75 nm thick, including NPB;

b.2) an exciton-blocking layer, 5 nm thick, including TCTA;

b.3) a first phosphorescent LEL, 2 nm thick, including CBP doped with about 1.0 vol % of Ir(Ppy)₃;

b.4) a first spacer, 2 nm thick, including aluminum(III) bis(2-methyl-8-hydroxyquinoline)-4-phenylphenolate (BAlq) which has a triplet energy=2.25;

c) a first fluorescent blue LEL, 10 nm thick, including BAlq doped with about 1.5 vol % of formula (N-7);

d.1) a second spacer, 5 nm thick, including BAlq;

d.2) a second phosphorescent LEL, 20 nm thick, including BAlq doped with about 8 vol % of I(piq)₃;

e) an ETL, 35 nm thick, including formula (P-2);

f) an EIL, 2 nm thick, including formula (X-1); and

g) cathode: approximately 150 nm thick, including Al.

Device 9 is denoted as: ITO/10 nm HAT-CN/75 nm NPB/5 nm TCTA/2 nm CBP:1.0 vol % Ir(ppy)₃/2 nm BAlq/10 nm BAlq:1.5 vol % (N-7)/5 nm BAlq/20 nm BAlq:8 vol % Ir(piq)₃/35 nm (P-2)/2 nm (X-1)/150 nm Al. The EL performance of the device is summarized in Table 2, and its EL spectrum is shown in FIG. 9.

Unlike Device 8, in Device 9, the first phosphorescent LEL is a green emission layer and the second phosphorescent layer is a red emission layer. This layer structure can also achieve reduced drive voltage, increased power efficiency, and improved color.

Another OLED (Device 10) was fabricated in accordance with the present invention. The fabrication method is the same as that of Example 1. The layer structure is as follows:

a) an HIL, 10 nm thick, including HAT-CN;

b.1) an HTL, 75 nm thick, including NPB;

b.2) an exciton-blocking layer, 5 nm thick, including TCTA (triplet energy=2.85);

b.3) a first phosphorescent LEL, 3 nm thick, including BAlq doped with about 8 vol % of Ir(piq)₃;

b.4) a first spacer, 1 nm thick, including CBP;

c) a first fluorescent blue LEL, 5 nm thick, including CBP doped with about 1.7 vol % of formula (N-7);

d.1) a second spacer, 4 nm thick, including formula (P-2) (triplet energy=2.64);

d.2) a second phosphorescent LEL, 15 nm thick, including formula (P-2) doped with about 5 vol % of Ir(ppy)₃;

e.1) a first ETL, 15 nm thick, including formula (P-2);

e.2) a second ETL, 10 nm thick, including formula (U-3);

f) an EIL, 2 nm thick, including formula (X-1); and

g) cathode: approximately 150 nm thick, including Al.

Device 10 is denoted as: ITO/10 nm HAT-CN/75 nm NPB/5 nm TCTA/3 nm BAlq:8 vol % Ir(piq)₃/1 nm CBP/5 nm CBP: 1.7 vol % (N-7)/4 nm (P-2)/15 nm (P-2):5 vol % Ir(ppy)₃/15 nm (P-2)/10 nm (U-3)/2 nm (X-1)/150 nm Al. The EL performance of the device is summarized in Table 2.

In Device 10, a second phosphorescent LEL is formed in the electron-transporting region. Therefore, the drive voltage is reduced and the power efficiency is increased.

Another OLED (Device 11) was fabricated in accordance with the present invention. The fabrication method is the same as that of Example 1. The layer structure is as follows:

a) an HIL, 10 nm thick, including HAT-CN;

b.1) an HTL, 75 nm thick, including NPB;

b.2) an exciton-blocking layer, 4 nm thick, including TCTA;

b.3) a first phosphorescent LEL, 0.5 nm thick, including CBP doped with about 8 vol % of Ir(piq)₃;

c) a first fluorescent blue LEL, 5 nm thick, including CBP doped with about 1.7 vol % of formula (N-7);

d.1) a second spacer, 4 nm thick, including formula (P-2);

d.2) a second phosphorescent LEL, 15 nm thick, including formula (P-2) doped with about 5 vol % of Ir(ppy)₃;

e.1) a first ETL, 15 nm thick, including formula (P-2);

e.2) a second ETL, 10 nm thick, including formula (U-3);

f) an EIL, 2 nm thick, including formula (X-1); and

g) cathode: approximately 150 nm thick, including Al.

Device 11 is denoted as: ITO/10 nm HAT-CN/75 nm NPB/4 nm TCTA/0.5 nm CBP:8 vol % Ir(piq)₃/5 nm CBP:1.7 vol % (N-7)/4 nm (P-2)/15 nm (P-2):5 vol % Ir(ppy)₃/15 nm (P-2)/10 nm (U-3)/2 nm (X-1)/150 nm Al. The EL performance of the device is summarized in Table 2.

There is no first spacer between the first phosphorescent LEL and the fluorescent blue LEL in Device 11. However, reduced voltage and increased power efficiency have also achieved in Device 11.

Another OLED (Device 12) was fabricated in accordance with the present invention. The fabrication method is the same as that of Example 1. The layer structure is as follows:

a) an HIL, 10 nm thick, including HAT-CN;

b.1) an HTL, 55 nm thick, including NPB;

b.2) a first phosphorescent LEL, 20 nm thick, including TCTA doped with about 8 vol % of Ir(piq)₃;

c) a first fluorescent blue LEL, 5 nm thick, including CBP doped with about 1.7 vol % of formula (N-7);

d.1) a second spacer, 4 nm thick, including formula (P-2);

d.2) a second phosphorescent LEL, 15 nm thick, including formula (P-2) doped with about 5 vol % of Ir(ppy)₃;

e.1) a first ETL, 15 nm thick, including formula (P-2);

e.2) a second ETL, 10 nm thick, including formula (U-3);

f) an EIL, 2 nm thick, including formula (X-1); and

g) cathode: approximately 150 nm thick, including Al.

Device 12 is denoted as: ITO/10 nm HAT-CN/55 nm NPB/20 nm TCTA:8 vol % Ir(piq)₃/5 nm CBP:1.7 vol % (N-7)/4 nm (P-2)/15 nm (P-2):5 vol % Ir(ppy)₃/15 nm (P-2)/10 nm (U-3)/2 nm (X-1)/150 nm Al. The EL performance of the device is summarized in Table 2.

Similar to Device 11, there is no first spacer between the first phosphorescent LEL and the fluorescent blue LEL in Device 12. However, reduced voltage and increased power efficiency have also achieved in Device 12.

The invention has been described in detail with particular reference to certain preferred OLED embodiments thereof, but it will be understood that variations and modifications can be effected within the spirit and scope of the invention.

### PARTS LIST

100 OLED
120 Anode
130 Hole-injecting layer (HIL)
140.1 Hole-transporting layer (HTL)
140.2 First phosphorescent light-emitting layer (First phosphor. LEL)
140.3 First Spacer
   (Layers 140.1, 140.2, and 140.3 are Considered the HTL Region)
150 Fluorescent blue light-emitting layer (Fluorescent blue LEL)
160.1 Second Spacer
160.2 Second phosphorescent light-emitting layer (Second phosphor. LEL)
160.3 Electron-transporting layer (ETL)
   (Layers 160.1, 160.2, and 160.3 are considered the ETL region)
170 Electron-injecting layer (EIL)
180 Cathode
200 OLED
300 OLED
400 OLED
500 OLED
600 OLED

1. An organic light-emitting device (OLED) comprising:
(a) an anode;
(b) a cathode;
(c) a blue light-emitting layer disposed between the anode and the cathode and includes at least one blue host and at least one fluorescent blue dopant;
(d) a first light-emitting layer disposed between the anode and the blue light-emitting layer, including a first phosphorescent dopant and a host; and
(e) a second light-emitting layer disposed between the blue light-emitting layer and the cathode, including a second phosphorescent dopant and a host.

2. The organic light-emitting device of claim 1 that produces white light.

3. The organic light-emitting device of claim 1 further including a first spacer disposed between the first light-emitting layer and the blue light-emitting layer, and wherein the first spacer is in contact with both the first light-emitting layer and the blue light-emitting layer.

4. The organic light-emitting device of claim 1 further including a second spacer disposed between the blue light-emitting layer and the second light-emitting layer, and wherein the second spacer is in contact with both the blue light-emitting layer and the second light-emitting layer.

5. The organic light-emitting device of claim 1 wherein the first light-emitting layer and the second light-emitting layer each have a thickness greater than 0.5 nm.

6. The organic light-emitting device of claim 3 wherein the thickness of the first spacer is in a range of from 1 to 15 nm.

7. The organic light-emitting device of claim 4 wherein the thickness of the second spacer is in a range of from 1 to 15 nm.

8. The organic light-emitting device of claim 1 wherein the thickness of the blue light-emitting layer is in a range of from 1 nm to 40 nm.

9. The organic light-emitting device of claim 1 wherein the blue fluorescent dopant includes a perylene derivative, a bis(azinyl)amine boron compound or a distyrylbiphenyl derivative.

10. The organic light-emitting device of claim 1 wherein the blue host in the blue light-emitting layer is selected from hole-transporting materials.

11. The organic light-emitting device of claim 10 wherein the blue host includes a carbazole derivative represented by formula (H): 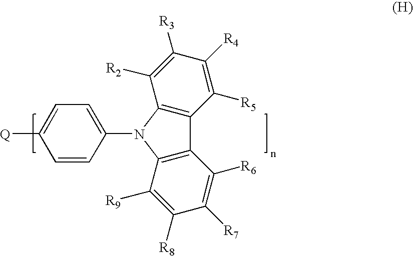
wherein:
n is an integer from 1 to 4; and
Q is nitrogen, carbon, an aryl, or substituted aryl; and
R₂-R₇ are independently hydrogen, an alkyl group, phenyl or substituted phenyl, an aryl amine, a carbazole and substituted carbazole.

12. The organic light-emitting device of claim 1 wherein the blue host in the light-emitting layer includes at least one electron-transporting material.

13. The organic light-emitting device of claim 12 wherein the blue host includes an aluminum or gallium complex represented by Formula (T-a): 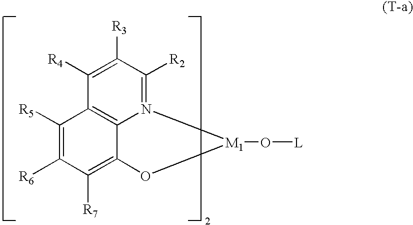
wherein:
M₁ is Al or Ga; and
R₂-R₇ independently represent hydrogen or an alkyl group; and
L is an aromatic moiety with 6 to 30 carbon atoms.

14. The organic light-emitting device of claim 3 wherein the material in the first spacer has higher triplet energy than that of the phosphorescent dopant in the first light-emitting layer.

15. The organic light-emitting device of claim 3 wherein the material in the first spacer includes the same material as the host in the first light-emitting layer.

16. The organic light-emitting device of claim 3 wherein the material in the first spacer includes the same material as the host in the blue light-emitting layer.

17. The organic light-emitting device of claim 4 wherein the material in the second spacer has higher triplet energy than that of the phosphorescent dopant in the second light-emitting layer.

18. The organic light-emitting device of claim 4 wherein the material in the second spacer includes the same material as the host in the blue light-emitting layer.

19. The organic light-emitting device of claim 1 wherein the material in the second spacer includes the same material as the host in the second light-emitting layer.

20. The organic light-emitting device of claim 1 wherein the host in the first light-emitting layer includes hole-transporting materials.

21. The organic light-emitting device of claim 20 wherein the hole-transporting host in the first light-emitting layer includes at least one of the following classes of materials:
a)tetraaryldiamines represented by Formula (D): 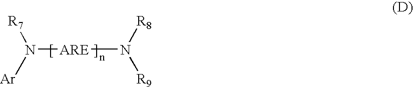
wherein:
each ARE is an independently selected arylene group; and
n is an integer of from 1 to 4; and
Ar, R₇, R₈, and R₉ are independently selected aryl groups; or
b)carbazoles represented by formula (H): 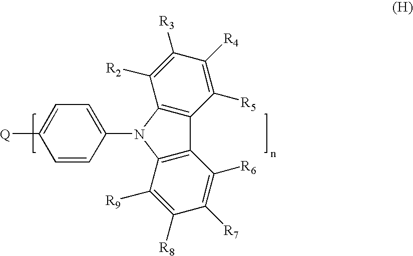
wherein:
n is an integer from 1 to 4; and
Q is nitrogen, carbon, an aryl, or substituted aryl; and
R₂-R₇ are independently hydrogen, an alkyl group, phenyl or substituted phenyl, an aryl amine, a carbazole and substituted carbazole.

21. The organic light-emitting device of claim 1 wherein the host in the second light-emitting layer includes an electron-transporting material.

22. The organic light-emitting device of claim 21 wherein the electron-transporting host in the second light-emitting layer includes at least one of the following classes of materials:
(a) aluminum or gallium complexes represented by Formula (T-a): 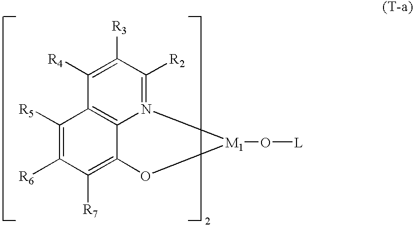
wherein:
M₁ is Al or Ga; and
R₂-R₇ independently represent hydrogen or an alkyl group; and
L is an aromatic moiety with 6 to 30 carbon atoms; or
(b) phenanthrolines as represented by formula (P): 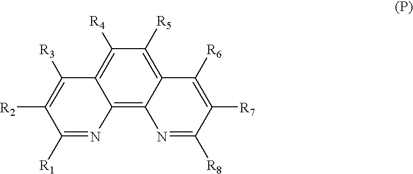
wherein:
R₁-R₈ are independently hydrogen, alkyl group, aryl or substituted aryl group, and at least one of R₁-R₈ is aryl group or substituted aryl group.

23. The organic light-emitting device of claim 1 wherein one of the non-blue light-emitting layers includes a green phosphorescent dopant and the other non-blue light-emitting layer includes a red phosphorescent dopant.

24. The organic light-emitting device of claim 1 wherein the phosphorescent dopant in the first light-emitting layer is selected from tris(1-phenylisoquinoline)iridium(III) (Ir(piq)₃) or tris(2-phenylpyridine)iridium(III) (Ir(ppy)₃).

25. The organic light-emitting device of claim 1 wherein the phosphorescent dopant in the second light-emitting layer is selected from tris(1-phenylisoquinoline)iridium(III) (Ir(piq)₃) or tris(2-phenylpyridine)iridium(III) (Ir(ppy)₃).
